(19) United States
(12) Patent Application Publication
(10) Pub. No.: US 2007/0039018 A1
(43) Pub. Date: Feb. 15, 2007

(54) Apparatus, systems and methods for broadcast advertising stewardship

(75) Inventors: Steven Andrew Saslow, Henryville, PA (US); Dean Anthony Angelico, Carlsbad, CA (US); Robert Richard Bagnall, San Diego, CA (US); Harold Samuel Geller, Edison, NJ (US); Cherri Lynn Klueck, La Mesa, CA (US)

Correspondence Address: Lipsitz & McAllister, LLC, 755 MAIN STREET, MONROE, CT, 06468, US

(73) Assignee: Verance Corporation, San Diego, CA (US)

(21) Appl. No.: 11/501,668

(22) Filed: Aug. 8, 2006

Related U.S. Application Data
(60) Provisional application No. 60/706,951, filed on Aug. 9, 2005.

(51) Int. Cl. H04H 9/00; H04N 7/16

(52) U.S. Cl. 725/22; 725/19; 725/9

(57) ABSTRACT

The present invention provides interactive and automated methods and systems that facilitate the improved stewardship of broadcast advertising by all industry participants. The system employs data from multiple sources, such as agency media management systems; broadcaster inventory and sales management systems; agency and broadcaster traffic management systems; and the ConfirMedia® broadcast monitoring system developed by Verance Corporation; as well as from third-party industry data sources such as electronic program guides, broadcaster and market population data, and audience rating services, to allow the fulfillment of broadcast advertising agreements to be verified and accounted for, and for discrepancies between various data sources to be identified and resolved.

This application claims priority from U.S. provisional application No. 60/706,951 filed on Aug. 9, 2005, which is incorporated herein and made a part hereof by reference for all purposes as if set forth herein in its entirety.

### FIELD OF THE INVENTION

The present invention relates to the stewardship of television, radio and cable broadcast advertising and, more specifically, to systems and applications for use in the provision of broadcast advertising stewardship services to a full range of diverse industry participants.

### BACKGROUND OF THE INVENTION

In contrast to industries where the fulfillment of a business transaction involves delivery of a product or service directly to the purchaser, the direct recipient of a completed broadcast advertising transaction is a targeted broadcast audience. This presents a problem for the advertiser (the buyer of the airtime) and other downstream participants in the transaction with respect to verifying the broadcaster's (the seller of the airtime) fulfillment of the transaction.

Because the advertisement is directed to a third-party (the broadcast audience), a mechanism independent of the fulfillment itself is necessary to confirm its delivery.

The industry's ability to establish efficient and accurate methods for stewarding advertising purchases, and for accounting for fulfillment of those purchases, has been significantly hampered by the nature and the complexity of the business processes by which units of advertising airtime are sold, as well as the processes by which corresponding commercial advertisements themselves are distributed to individual broadcasters for airing in fulfillment of those purchases.

Consider, for example, the placement of a single advertisement on a local broadcast station. An agreement to carry the advertisement may be sold to the advertiser by the local station directly, by an advertising representation firm acting as agent for the local station, by a program syndicator that places the advertisement on the local station in connection with the station acquiring rights to air a program, by a network that places the advertisement on a collection of local affiliate stations bundled with a package of network programming, or, most commonly, by an advertising agency who has purchased and/or will agree to purchase blocks of advertising time from any or all of the previously listed sources for use by their advertising clients.

Likewise, the actual commercial advertisements that local broadcasters need to air, and the specific airing instructions the broadcaster must follow in order to fulfill the original purchase agreement, may be distributed to them either directly by the advertiser or their advertising agency, or indirectly through any of the participants defined above, including an advertising representation firm, a program syndicator or a broadcast network, depending upon the nature of the original purchase transaction.

Broadcast advertising stewardship is the process by which the various participants in the broadcast advertising industry manage and account for the fulfillment of these complex broadcast advertising orders. Current industry practice relies on all participants in the value chain between the advertiser and the audience making best efforts to steward their obligations and, where appropriate, to demand effective stewardship by downstream participants.

The predominant current business practice for this is self-reporting—that is, each party either reports on their own activities or requests fulfillment reports from their downstream providers, and uses these third party reports as the basis for accounting for their own fulfillment.

The reliance on a chain of unverified self-reporting introduces inaccuracies and delays into the industry's accounting for performance that detracts significantly from the value received by participants. Unverified reporting enables erroneous claims that mislead participants. Delayed information regarding airplay fulfillment complicates efforts to identify and correct mismatches between advertising orders and fulfillment, reducing the effectiveness of the medium at meeting advertisers' goals. Self-reporting also has a high cost, because each participant is required to collect (and make best efforts to verify) and distribute information regarding fulfillment, often manually and from disparate sources.

Adding to the complexity of the stewardship processes is the fluid nature of the specific parameters of purchase agreements throughout the lifecycle of each agreement and its fulfillment. Evolving business objectives and advertising needs on the part of the advertiser, as well as constantly changing supply-and-demand pressures on each broadcaster's finite inventory of advertising airtime, (which can be subject to preemption by either the broadcaster's revenue objectives and/or forces beyond their control, such as weather, natural disaster breaking news, and technical breakdowns) are the main contributors to this fluidity.

These issues, all of which are well known to, and accepted by, those in the industry, illustrate just some of the ways in which the overall business environment is negatively impacted by current practices.

The present invention relates to improving these practices through the introduction of improved systems for streamlining and managing the related activities and interactions of various industry participants throughout the purchase, delivery, fulfillment, accounting, and value chains.

### SUMMARY OF THE INVENTION

The purpose of the present invention is to provide interactive and automated apparatus, systems, and methods that facilitate the improved stewardship of broadcast advertising by all industry participants. The example embodiments of the present invention utilizes data from multiple sources, such as agency media management systems, broadcaster inventory and sales management systems, broadcaster billing systems, agency and broadcaster traffic management systems, and the ConfirMedia® broadcast monitoring system developed by Verance Corporation, as well as from third-party industry data sources such as electronic program guides, broadcaster directories, market population data, and audience measurement and rating services, to allow the fulfillment of broadcast advertising agreements to be verified and accounted for, and for discrepancies between various data sources to be identified and resolved.

The present invention provides methods, apparatus, and systems for broadcast program stewardship. In an example embodiment of the present invention, a method for broadcast program stewardship is provided. Broadcast multimedia content is monitored to produce detection information relating to one or more broadcast instances of one or more broadcast items. Schedule information related to the one or more broadcast items is also received. The detection information is then compared against the schedule information. Using such a method, it can be determined, for example, whether a commercial, television program, or a song aired at the appropriate time and/or the appropriate number of times.

For each of the one or more broadcast items, the detection information may comprise at least one of date and time of the broadcast item, duration of the broadcast item, type of broadcast of the broadcast item, owner of the broadcast item, title of the broadcast item, at least one code associated with the broadcast item, or other similar information identifying or relating to the particular broadcast item at issue.

The detection information may be produced in accordance with at least one of a broadcast monitoring coverage and a station outage data. Broadcast monitoring coverage may comprise, for example, monitoring by a monitoring station which receives all broadcast content and analyses it to obtain the detection information. Station outage data may comprise, for example, data indicating the times/durations of a monitoring station outage.

In one example embodiment of the present invention, the detection information may be produced in accordance with watermarks extracted from the one or more broadcast items. Alternatively, the detection information may be produced in accordance with fingerprints extracted from the multimedia content.

The broadcast items may comprise at least one of commercials, infomercials, television programs, radio programs, news programs, cable programs, satellite programs, podcasts, Internet broadcasts, downloads, broadcasts of live events, and the like.

The schedule information may comprise purchase details relating to each of the one or more broadcast items. The purchase details may comprise at least one of a seller's name, a purchaser's name, a purchaser's product(s) being promoted, an estimate number corresponding to the purchase, an invoice number corresponding to the purchase, a number of agreed upon contract units, a number of invoiced units, a length of the contract units to be broadcast, a length of the invoiced units, broadcast dates and times of the contract units, broadcast dates and times of the invoiced units, negotiated costs for each contract unit, invoiced costs for each invoiced unit, and the like.

In a further example embodiment of the present invention, additional information may be received (e.g., at the monitoring station comparing the schedule information with the detection information or by a service provider controlling operation of the system). This additional information may comprise at least one of an agency schedule, a broadcaster contract, a broadcaster invoice, a network affiliate lineup, a station lineup, agency traffic instructions, change order information, broadcaster program schedule data, broadcaster data, market population data, audience measurement ratings data to effect the comparing, or the like.

At least a portion of the additional information may be received electronically. The electronically received information may be automatically uploaded into a database. At least a portion of the additional information may be manually uploaded into a database.

At least a portion of the additional information may be received from users in accordance with pre-defined security permission levels. The permission levels may comprise at least one of a customer account level, a customer administrator level, and a user level.

In another example embodiment of the present invention, schedule information may be received electronically and automatically uploaded into a database. At least a portion of the schedule information may be received from users in accordance with pre-defined security permission levels. The permission levels may comprise at least one of a customer account level, a customer administrator level, and a user level.

In a further example embodiment of the present invention, the comparing of the detection information against the schedule information may comprise matching the detection information and the schedule information in accordance with a matching algorithm. The matching algorithm may comprise at least one of a hierarchical matching algorithm, a point-to-point matching algorithm, a point-to-range matching algorithm, or the like.

In one example embodiment, the comparing may comprise selecting one or more matching criteria, assigning weighted scores to the selected matching criteria, and matching the detection information and the schedule information in accordance with the matching criteria and the weighted scores. A match may be declared if all of the matching criteria are satisfied. A partial match may be declared if at least one of the matching criteria is satisfied. No match is declared if none of the matching criteria are satisfied.

A report may be generated based on the comparing. The report may be provided on-line. The report may comprise at least one of an agency schedule to detections match, an agency schedule supplemented with network affiliate lineup data to detections match, an agency schedule supplemented with station lineup data to detections match, a broadcaster invoice to detections match, a broadcaster contract or deal to detections match, a broadcaster contract or deal to broadcaster contract or deal match, an agency traffic instructions to detections match, change order information to detections match, a broadcaster program schedule to detections match, or the like. The matches may comprise at least one of detections supplemented with broadcaster data, detections supplemented with market population data, and detections supplemented with audience measurement ratings data.

At least portions of the report are accessible in accordance with predefined security permission levels. The permission levels may comprise at least one of a customer account level, a customer administrator level, and a user level. At least portions of the report may be electronically exportable.

In another example embodiment of the present invention, the method may further comprise generating traffic alerts. The traffic alerts may identify inconsistencies between agency traffic instructions and the detection information. The inconsistencies may comprise at least one of an incorrect rotation, a missed upload date, a missed start, an out-of-flight broadcast, a blackout period broadcast, an incorrect broadcaster, or the like.

In a further example embodiment, the comparing may be effected in accordance with change order information. The change order information may be produced in accordance with least one of interrogation of broadcaster contracts, direct importation of the change order information from broadcasters, manual entry of the change order information, or the like. The change order information may comprise at least one of unassociated added units, unassociated removed units, and pre-associated added and removed units. The change order information may further comprise at least one of sellers associating unassociated added and removed units and submitting them to a buyer and sellers submitting pre-associated added and removed units to a buyer. The change order information may also comprise at least one of submitted change order information approved by the buyer and submitted change order information rejected by the buyer.

In an additional example embodiment of the present invention, the method may further comprise receiving invoice information related to the broadcast items and comparing the detection information against the invoice information. The invoice information may comprise at least one of original invoice information and change order information related to the original invoice information.

The present invention also includes further embodiments directed towards program clearance and commercial clearance using broadcaster lineup information. In such an example embodiment, broadcast multimedia content may be monitored to produce detection information relating to one or more broadcast instances of one or more broadcast items. Broadcaster lineup information may be received which is related to the one or more broadcast items. The detection information may then be compared against the lineup information. In this manner, it can be determined whether a commercial or program has been cleared (e.g., aired at or about the appropriate time or number of times in accordance with agency schedules and broadcaster lineups or any change orders related changes in schedules or lineups).

For each of the one or more broadcast items, the detection information may comprise at least one of date and time of the broadcast item, duration of the broadcast item, type of broadcast of the broadcast item, owner of the broadcast item, title of the broadcast item, at least one code associated with the broadcast item, or other similar information identifying or relating to the particular broadcast item at issue.

The detection information may be produced in accordance with at least one of a broadcast monitoring coverage and a station outage data. The detection information may be produced in accordance with watermarks extracted from the one or more broadcast items. Alternatively, the detection information may be produced in accordance with fingerprints extracted from the multimedia content.

The broadcast items may comprise at least one of commercials, infomercials, television programs, radio programs, news programs, cable programs, satellite programs, podcasts, Internet broadcasts, downloads, broadcasts of live events, and the like.

The lineup information may comprise scheduled broadcasts details corresponding to the one or more broadcast items. The scheduled broadcast details may comprise at least one of a number of scheduled broadcast items, a number of markets for the scheduled broadcast items, a time and date for the scheduled broadcast items, a number of broadcast stations to broadcast the scheduled broadcast items, a percentage of total population associated with each of the markets, and the like.

In a further example embodiment of the present invention, additional information may be received. This additional information may comprise at least one of a broadcaster contract, a broadcaster invoice, a network affiliate lineup, a station lineup, an agency schedule, agency traffic instructions, change order information, broadcaster program schedule data, broadcaster and market population data, and audience measurement ratings data to effect the comparing.

At least a portion of the additional information may be received electronically. The electronically received information may be automatically uploaded into a database. At least a portion of the additional information may be manually uploaded into a database.

At least a portion of the additional information may be received in accordance with pre-defined security permission levels. The permission levels may comprise at least one of a customer account level, a customer administrator level, and a user level.

In another example embodiment of the present invention, the lineup information may be received electronically and automatically uploaded into a database. At least a portion of the lineup information may be received in accordance with pre-defined security permission levels. The permission levels may comprise at least one of a customer account level, a customer administrator level, and a user level.

In a further example embodiment of the present invention, schedule information related to the broadcast items may also be received. In such an embodiment, the comparing may comprise matching the detection information and the schedule information in accordance with a matching algorithm. The matching algorithm may comprise at least one of a hierarchical matching algorithm, a point-to-point matching algorithm, a point-to-range matching algorithm, or the like. The matching algorithm may also comprise selecting one or more matching criteria, assigning weighted scores to the selected matching criteria, and matching the detection information and the schedule information in accordance with the matching criteria and the weighted scores. A match may be declared if all of the matching criteria are satisfied. A partial match may be declared if at least one of the matching criteria is satisfied. No match is declared if none of the matching criteria are satisfied.

A report may be generated based on the comparing. The report may be provided on-line. The report may comprise at least one of an agency schedule to detections match, an agency schedule supplemented with network affiliate lineup data to detections match, an agency schedule supplemented with station lineup data to detections match, a broadcaster invoice to detections match, a broadcaster contract or deal to detections match, a broadcaster contract or deal to broadcaster contract or deal match, an agency traffic instructions to detections match, change order information to detections match, a broadcaster program schedule to detections match, or the like. The matches may comprise at least one of detections supplemented with broadcaster data, detections supplemented with market population data, and detections supplemented with audience measurement ratings data.

At least portions of the report are accessible in accordance with predefined security permission levels. The permission levels may comprise at least one of a customer account level, a customer administrator level, and a user level. At least portions of the report may be electronically exportable.

In another example embodiment of the present invention, the method may further comprise generating traffic alerts. The traffic alerts may identify inconsistencies between agency traffic instructions and the detection information. The inconsistencies may comprise at least one of an incorrect rotation, a missed upload date, a missed start, an out-of-flight broadcast, a blackout period broadcast, an incorrect broadcaster, or the like.

In a further example embodiment, the comparing may be effected in accordance with change order information. The change order information may be produced in accordance with least one of interrogation of broadcaster contracts, direct importation of the change order information from broadcasters, manual entry of the change order information, or the like. The change order information may comprise at least one of unassociated added units, unassociated removed units, and pre-associated added and removed units. The change order information may further comprise at least one of sellers associating unassociated added and removed units and submitting them to a buyer and sellers submitting pre-associated added and removed units to a buyer. The change order information may also comprise at least one of submitted change order information approved by the buyer and submitted change order information rejected by the buyer.

In an additional example embodiment of the present invention, the method may further comprise receiving invoice information related to the broadcast items and comparing the detection information against the invoice information. The invoice information may comprise at least one of original invoice information and change order information related to the original invoice information.

In a further example embodiment of the present invention, the comparing may produce at least one of a cleared match type, a partially cleared match type, a not cleared match type, an unscheduled airing match type, and the like.

Example embodiments of apparatus and systems for carrying out the foregoing methods (or parts or combinations thereof) are also provided in accordance with the present invention. Further, those skilled in the art will appreciate that the various example embodiments described above, or particular features of those example embodiments, may be combined in various ways to provide further embodiments.

### BRIEF DESCRIPTION OF THE DRAWINGS

The present invention will hereinafter be described in conjunction with the appended drawing figures, wherein like reference numerals denote like elements, and:

FIG. 1 illustrates a general block diagram of the an example embodiment of the present invention;

FIG. 2 is a flow chart describing the change order process with electronic ingestion of changes in accordance with an example embodiment of the present invention;

FIG. 3 is a flow chart describing the change order process with manual ingestion of changes in accordance with an example embodiment of the present invention; and

FIG. 4 illustrates a block diagram of data flow within a system in accordance with an example embodiment of the present invention.

The Appendix illustrates several examples of the matching functionality in accordance with example embodiments of the present invention, and is respectfully incorporated herein and made a part hereof by reference for all purposes as if fully set forth herein.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

One example of an implementation of an example embodiment of the present invention is the ‘ConfirMedia Online’ system provided by Verance Corporation (“Verance”) the assignee of the present invention. ConfirMedia Online is a web-based application that customers use to:
Securely import proprietary broadcast advertising media data into the ConfirMedia® system developed by Verance;
Query and display summaries and detailed matching analyses of password-protected data specific to broadcast advertising media sales and purchases that they are authorized to access;
Generate mutually agreed upon change order requests that will automatically update and synchronize sale/purchase data in the broadcaster's and agency's respective, non-integrated systems; and
Initiate timely, system generated, outbound notifications of instances in which specific commercials are airing outside of the parameters of the Agency Schedule and/or Agency Traffic Instructions.

In order to fully describe the features, functionalities and capabilities of the present invention, the following key concepts and components of the broadcast advertising and monitoring industry must be described in further detail.

Key Broadcast Advertising Industry Participants

As discussed above, part of the complexity of stewarding and fulfilling broadcast advertising media purchases stems from the large number of different roles that have emerged throughout the industry over time. While the broadcast industry continues to evolve on an ongoing basis, the roles described below are well established.
Advertisers are entities (such as for-profit corporations, governmental organizations, public interest groups, political candidates) that purchase broadcast advertising airtime in order to deliver an advertisement to an audience in order to further their own interest. Advertisers may purchase advertising directly or hire an advertising agency to do so on their behalf.
Advertising Agencies (or Agencies) provide one or more fee-based services to advertisers, including planning, purchasing and scheduling, as well as stewardship and billing of broadcast advertising airtime; as well as production, distribution and stewardship of individual commercial advertisements to be aired by broadcasters, along with their airing instructions in order to fulfill a purchase of airtime. Additionally, agencies often purchase broadcast airtime from broadcast networks and broadcast affiliates in blocks on a corporate basis for multiple advertising clients. In such instances, which are typical, the initial purchasing of the broadcast advertising airtime is a separate process from the allocation, scheduling and trafficking of each client's inventory of airtime for individual brands and products over time.
Advertising Sales Representatives act as sales brokers on behalf of broadcast networks and broadcast affiliates/local stations to sell airtime on multiple broadcasters to advertisers and their agencies.
Program Producers create broadcast programming such as entertainment, news, documentaries, etc. for use by broadcasters, primarily to attract an audience that will also receive their broadcast advertising.
Program Syndicators obtain programming from program producers, sell broadcast advertising time in those programs, and provide the programming and advertising together as a package to broadcasters.
Broadcast Networks are similar to program syndicators, however networks typically provide multiple programs (bundled with advertisements) to downstream broadcasters (their broadcast affiliates) together as a branded package (a network) and program syndicators typically provide individual programs. In some instances, broadcast networks may also broadcast directly to an audience, rather than through a downstream broadcaster.
Local Stations provide a broadcast stream, typically comprised of both programming and advertising, directly to an audience. Local stations that broadcast content received from broadcast networks are referred to as broadcast affiliates. In some cases, such as cable television broadcasts, a Broadcast Distributor may act as an intermediary between a broadcast network or local stations and its audience.
   Broadcast Advertising Industry Data

Another contributing factor to the complexity of stewarding and fulfilling broadcast advertising media purchases stems from the number of different disparate sources and formats of industry data, as well as the fact that this data is often generated and maintained inconsistently in different industry participants' independent internal systems. Examples of these disparate sources and formats of the various types of broadcast advertising industry data include:
Agency Schedules (also Schedules or Buys) are generated by agency staff in the agency's internal media management system. Agency media management systems are primarily designed to be utilized by staff in the agency's finance department to process and pay invoices from broadcasters, and to in turn bill appropriate advertiser clients. However, these accounting and finance systems are also utilized by staff in the agency's media department to define the evolving details of the broadcast advertising media purchase, including:
   The name of the specific advertiser or agency purchasing the air time;
   The specific advertiser and the specific advertiser's brand(s) or product(s) being promoted by the advertising;
   The specific estimate number to which the advertising should be allocated (estimate numbers are used primarily internally by agencies to group advertising expenditures for accounting purposes, similar to the way purchase order numbers and other budgeting codes are used in other industries);
   The specific number of units the agency has agreed to purchase on behalf of the advertiser's brand(s) or product(s), and that the broadcaster has agreed to air on behalf of those brand(s) or product(s);
   The length of the units of advertising airtime sold/purchased to be aired (e.g., :15, :30, :60 seconds, etc.);
   The specific dates and times at which the sold/purchased units of advertising airtime are to air; and
   The negotiated and agreed-upon costs for each of those units of advertising airtime.

Importantly, the specific details of an Agency Schedule often change throughout the periods before, during and even after the originally scheduled airings. However, for a Broadcaster's Invoice to be paid by an agency, after all of the advertising activity is complete, the details of the Agency Schedule in the agency's internal media management system must have been manually updated to reflect any changes made throughout the campaign, and to be in synch with the activity ultimately reflected on the Broadcaster's Invoice generated by the broadcaster's internal inventory and scheduling management system. Another complicating factor is the variety of agency media management system providers from which the different agencies purchase their individual systems. While the majority of the core advertising schedule data in these systems are the same (i.e. advertiser, brand/product, estimate number, number of units, spot lengths, air dates and times, spot costs, etc.), the formats of files and of the individual data fields within those files upon export from each system vary significantly. Additionally, the same system is often configured and utilized differently by users in different agencies, and even by different users within the same agency, which also impacts the format of any data output.
Broadcaster Deals/Contracts are generated by broadcasters in their internal sales inventory management systems to define similar details of the sale/purchase as those defined in the Agency Schedule in the agency media management system. In fact, some broadcasters generate an original Deal/Contract and export the data directly to the agency's internal media management system, where it automatically becomes the basis for the original Agency Schedule in that system. As with agency media management systems, there are a variety of broadcaster sales inventory management system providers, each offering different systems that are utilized by different broadcasters. Furthermore, broadcaster sales management systems also are often configured and utilized differently by users at different broadcasters, and even by different users at the same broadcaster. Further complicating the communication and data flow and work processes is the fact that there is limited, if any, meaningful connectivity or integration between these agency systems and broadcaster systems.
Change Orders are typically generated offline by both agencies and broadcasters to modify any of the details of the purchase contained in the Agency Schedule and/or a Broadcaster's Deal/Contract before, during and/or after an advertising campaign has aired. These ongoing changes must be reflected and reconciled in both the agency's media management system and the broadcaster's billing system in order for Broadcaster Invoices to match up to Agency Schedules before the agency will agree to pay the broadcaster. However, these modifications to the original data are typically made offline without the structure, connectivity or integration of any automated systems, and without any standardized file or data formatting.
Network Affiliate/Station Lineups are the lists provided to the agency by a network or syndicated broadcaster of the multiple individual local stations in each television and/or radio market that are contracted to air network or syndicated programming and/or commercials based on each station's affiliation with either a radio network, a television network or a television program syndicator. Lineups detail the specific start date(s) and time(s) each station is contracted to air specific programming and/or commercials. The data components upon which Network Affiliate/Station Lineups are based typically reside in different areas of different systems within the broadcaster's environment, and are aggregated primarily manually offline, with little if any automation, and no standardized file or data formatting.
Agency Traffic Instructions identify how specific commercials (based on unique industry commercial spot identification codes, either ISCI or AdID) should air in order to properly fulfill the purchased Agency Schedule. Agency Traffic Instructions are typically generated offline in a document or spreadsheet format by staff in the agency's traffic department (which is responsible for providing commercial materials and instructions as to how each commercial is to air to each broadcaster on the Agency Schedule; and which functions relatively autonomously from the agency's media department where Agency Schedules are developed). These instructions are communicated to staff in the broadcaster's traffic department (which is responsible for taking in commercial materials and instructions, and making sure that each commercial airs precisely as per the agencies' instructions; and which functions relatively autonomously from the broadcaster's sales department, where the details reflected in the Agency Schedules and Broadcaster Deals/Contracts are established).
Local Station Affidavits of Performance are notarized documents provided by affiliate stations to broadcast networks or syndicators declaring the ID codes, air dates and air times of spots aired in order to fulfill each station's contractual obligations for airing specific programming and commercials as an affiliate of either a radio network, a television network or a television syndicate, and become the basis radio network, television network and syndicated television Broadcaster Invoices.
Broadcaster Invoices are generated by the broadcaster's internal billing system, based on both the original Broadcaster Deal/Contract and/or Agency Schedule data, which needs to have been updated by approved Change Order data, and ostensibly verified by Affidavits of Performance (including those from each individual affiliated station, in the case of radio networks, television networks and television syndicators). Broadcaster Invoices typically include the broadcaster's (the seller's) name, the broadcaster's invoice number corresponding to the purchase, the total numbers of invoiced units, the length of each invoiced unit, the specific broadcast dates and times of each invoiced unit, and spot identification codes for each invoiced unit for every commercial advertisement aired by each broadcaster for each advertiser's brand(s)/product(s) and estimate(s). Again, there are a variety of broadcaster system providers, each offering different systems which are utilized by different broadcasters, which are often configured and utilized differently by users at different broadcasters, and even by different users at the same broadcaster. Further complicating the communication and data flow and work processes is the fact that there is limited, if any, meaningful connectivity or integration between agency systems and broadcaster systems.
   ConfirMedia® Data

ConfirMedia® Detection Data verifies the date and time of programs and commercials that have been uniquely encoded with a particular watermark and subsequently have aired on specific monitored broadcasters. The embedded and/or detected watermarks are also linked to detailed metadata in the ConfirMedia® database identifying information such as the media type (local cable, national cable, network radio, network television, spot radio, spot television, or syndicated television), owner (agency, advertiser, brand/product, and estimate number for commercials, and broadcaster for programs), commercial or program ID code, commercial or program length, and commercial or program title of the specific program or commercial content. This information has been associated in the ConfirMedia® database with each unique watermark.

It should be also noted that the detection of airplay events can be carried out using fingerprinting, watermarking, or a combination of both techniques. Unlike watermarking, which requires the insertion of a foreign signal, i.e., the watermark signal, into the host content, fingerprinting techniques identify target broadcast programs in accordance with a unique function that is produced/calculated by just analyzing the host signal. This unique function, or ‘fingerprint,’ is typically calculated prior the broadcast of the program, and stored in a database. The monitoring stations receive the broadcast multimedia content, calculate the fingerprints associated with the received content, and compare the calculated fingerprints to those pre-existing in the database in search of a match. Watermarking and fingerprinting techniques for broadcast monitoring are discussed in several prior art publications.

Furthermore, the terms ‘airplay’ and ‘broadcast monitoring’ used throughout the present invention are not intended to limit the scope of the present invention to merely programs that are broadcast over the airwaves. It is well understood that the various embodiments of the present invention are equally applicable to all multimedia content that originate from different sources and reach a target audience through a variety of means. Some examples include Internet broadcasts, downloads, podcasts, cable and satellite programming, and the like. The term ‘program’ is also used in the present invention to comprise a variety of multimedia content such as commercials, infomercials, TV and radio programs, news programs, live events, and the like.

Active/Monitored Station Data is also maintained in the ConfirMedia® Data Management System (DMS) in order to provide additional information to customers regarding which broadcasters included on any Agency Schedules, Broadcaster Deal/Contracts, Change Orders, Agency Traffic Instructions, Network Affiliate/Station Lineups, or Broadcaster Invoices, were being actively monitored and reported at any given time, and which ones were not, thereby resulting in unmatchable, unverifiable items in their data in the system.

Outage Data is also maintained in the ConfirMedia® DMS in order to provide additional information to customers regarding any Confirmedia® system outages that occurred that might have resulted in additional unmatchable, unverifiable data lines in the system.

Additional 3^{rd} Party Industry Data

Television Program Schedule Data is also maintained in the ConfirMedia® DMS and appended to airplay event data in order to provide additional information to customers regarding specific programming scheduled to air on each local television broadcaster in each market at the time each commercial was detected on that broadcaster during any unencoded programming.

Broadcaster & Market Population Data is also maintained in the ConfirMedia® DMS and appended to airplay event data in order to provide additional information to customers regarding things like broadcaster call sign changes, relative market size and population delivery etc.

Audience Measurement/Ratings Data is also maintained in the ConfirMedia® DMS and appended to airplay event data in order to provide additional information to customers regarding measured audience size delivery of verified programming and commercials. The standard Audience Measurement/Ratings Data utilized by the industry is provided by two primary sources. Nielsen Media Research divides the country into 210 television markets (referred to as Designated Market Areas or DMA's, both of which are trademarks of the Nielsen Media Research), and provides the data for base population and sampled TV viewership patterns in each of those markets. This information is delivered to advertisers, agencies and broadcasters for the purposes of quantifying audience size and delivery for advertising schedules, and upon which the costs of the airtime for those schedules are negotiated and based. Similarly, Arbitron, Inc. divides the country into 297 radio markets (referred to as Metro Markets or Metros, both of which are trademarks of the Arbitron, Inc.), and provides the data for population and sampled radio listenership patterns in each of those markets for those same purposes regarding radio advertising.

### OBJECTIVES OF EXAMPLE EMBODIMENTS OF THE PRESENT INVENTION

One goal of the present invention is to provide a transparent, end-to-end broadcast advertising media stewardship service for all industry participants. As such, the workflow surrounding the present invention is an important aspect of the system. The present invention provides methods, apparatus, and systems that combine planned or declared media schedules with airplay events collected by the ConfirMedia® Broadcast Monitoring System (BMS), and produces various discrepancy reports including, for example, instances where an airing documented in Agency Schedule data and/or Broadcaster Deal/Contract data and/or Agency Traffic Instruction data and/or Broadcaster Invoice data cannot be matched up to a corresponding airing in Online Detection data provided in accordance with an example embodiment of the present invention. This combining, comparing and matching of various sets of data is configured through a set of administrative interfaces as well as a set of customer interfaces. However this simple view of the system may be misleading. First of all, the data being combined is voluminous, complex, and varies in both format and content from customer to customer. Second, the data is updated frequently, at different intervals, and often inconsistently in the different participants' internal systems, which also do not interact. Third, much of the data may not be available in a form that is easily imported in an automatic fashion. A key challenge in implementing an embodiment of the present invention is to make all this complexity simple, automatic, and accurate for disparate sets of users, using disparate, non-integrated systems, in disparate environments.

Potential Audiences for Various Embodiments of the Present Invention

The potential audiences for the features provided by the present invention include media, finance and traffic staff in advertising agencies; and sales, finance and traffic staff in broadcaster companies.

General description of an Example Embodiment of the Present Invention

Data Access & Security

In an example embodiment, the present invention ensures data security and integrity by providing administrative functions for assigning account-level and user-level data access and system feature access permissions for each account, as well as for each user on each account. Only designated users assigned administrative privileges by a system provider shall have access to these administrative functions, allowing them to in turn assign various combinations of data access and system feature access permissions to individual users on their respective accounts. These access and security permissions are based upon various combinations of characteristics of each account and of each user on each account, including:
Company type: In one example, a system embodiment of the present invention is designed to recognize two primary types of accounts based on the type of company the account is established for:
   1. Broadcaster Accounts and
   2. Agency Accounts.

In turn, the system may also recognize two primary types of users and data, based on which one of those two primary account types the users and the data are associated with.

Online Broadcaster Accounts may be established for the sellers and broadcasters of broadcast advertising airtime, primarily television networks, television syndicators, radio networks, cable networks, local television stations, local radio stations, and local cable system operators.

Online Agency Accounts may be established for the buyers of broadcast advertising airtime, primarily advertisers and their advertising agencies.

An example of data access permissioning based on company type would be the fact that users on a broadcaster account have access to data for advertising for all advertisers that airs on their network or station, but would not have access to data for that same advertising for those same advertisers that airs on other networks or stations. Similarly, users on an agency account have access to data for their advertising that airs on their any networks or stations, but would not have access to data for any advertising that airs on those same networks or stations for other advertisers.

An example embodiment of the present invention featuring permissioning based on company type would be the fact that only users on Agency Accounts are allowed to import agency schedule or agency traffic instructions data into the system; and that only users on Broadcaster Accounts are allowed to import broadcaster invoice data, broadcaster deal/contract data and/or broadcaster network lineup data into the system. While only two account types are listed above to facilitate the understanding of the present invention, it is understood that additional accounts may be added and recognized by the system without departing from the scope of the invention.
Media Type: The present invention may be implemented to recognize at least the following seven primary Media Types recognized by both broadcasters and advertisers/agencies in the broadcast advertising industry:
   1. Local Cable: Airtime sold directly by local cable system operators; advertising is broadcast only to households on that system in that market;
   2. National Cable: Airtime sold directly by national cable networks; advertising airs on that network on all local cable systems in all markets throughout the country;
   3. Network Radio: Airtime sold by the radio networks; advertising is broadcast on all affiliate radio stations in all local radio markets throughout the country;
   4. Network Television: Airtime sold by the TV networks; advertising is broadcast on all affiliate TV stations in all local TV markets throughout the country;
   5. Spot Radio: Airtime sold directly by local radio stations; advertising is broadcast only on that radio station in that market;
   6. Spot Television: Airtime sold directly by local TV stations; advertising is broadcast only on that TV station in that market;
   7. Syndicated Television: Airtime sold by the program syndicators; advertising is broadcast on all affiliate TV stations in all local TV markets throughout the country.

An example of data access permissioning based on media type in accordance with an example embodiment of the present invention would be the fact that media buyers in agencies who are responsible for buying network television advertising airtime are not typically allowed to have access to proprietary advertising schedules from buyers who are responsible for buying spot radio advertising airtime. Consequently, the present invention may provide tools for administrative users on each account to assign specific media type permissions to each user on their account that limit the data each user is allowed to access based on the media type.

Another example of access permissioning based on media type would be the fact that affiliate lineup data (the listings of affiliate stations in each market that are contractually obligated to air network programming and commercials a specified number of times during specified date/time ranges) is relevant only for network radio, network television and syndicated television advertising, and not for local cable, national cable, spot radio or spot television advertising. Consequently, the present invention may provide onscreen tools to allow only users on broadcaster accounts permissioned for network radio, network television and/or syndicated television to import affiliate lineup data into the system.
Agency: The present invention may be designed to associate one or more permissioned Agency data to each user on each agency and each broadcaster account. In turn, each user then only has access to data within the system that is also associated with that Agency or those Agencies.
Advertiser: The present invention may be designed to associate one or more permissioned Advertiser data to each user on each agency and each broadcaster account. In turn, each user then only has access to data within the system that is also associated with that Advertiser or those Advertisers.
Brand/Product: The present invention may be designed to associate one or more permissioned Brand/Product data to each user on each agency and each broadcaster account. In turn, each user then only has access to data within the system that is also associated with that Brand/Product or those Brands/Products.
Market: The present invention may be designed to associate one or more permissioned television and/or radio Market data to each user on each agency and each broadcaster account. In turn, each user then only has access to data within the system that is also associated with that that television and/or radio Market or those television and/or radio Markets.
Broadcaster: The present invention may be designed to associate one or more permissioned television and/or radio Broadcaster data to each user on each agency and each broadcaster account. In turn, each user then only has access to data within the system that is also associated with that television and/or radio Broadcaster or those television and/or radio Broadcasters.
   Permissioned Customer Data

Example embodiments of the present invention support the full range of broadcast advertising industry data, comprising:
Agency Schedule Data: The agency's version of advertising schedules maintained in their internal media management system, including primarily the numbers of commercial units scheduled to air during specified date/time ranges on specified broadcasters at specified costs.
Agency Traffic Instructions Data: Directions from agencies to broadcasters as to specifically which versions of which commercials are to air in each slot on each advertiser's schedule.
Broadcaster Deal/Contract Data: The broadcaster's version of the advertising schedule maintained in their internal sales inventory and scheduling management system, including primarily the numbers of commercial units scheduled to air during specified date/time ranges on specified broadcasters at specified costs.
Affiliate Lineup Data: Listings maintained in network and syndicated broadcasters' internal systems of affiliate stations in each market that are contractually obligated to air network and syndicated programming and commercials a specified number of times during specified date/time ranges.
Broadcaster Invoice Data: Broadcasters' accounting of the numbers of specific advertising units aired for specified advertisers on specified dates and at specified times, and the associated costs now due to the broadcaster from the advertiser or their agency for the airings of those units.
   Customer Data Uploads

Example embodiments of the present invention also include functionality for broadcaster and agency user types to export the various types of proprietary data described above from their respective internal data management systems into the system database, including automatic upload, download, and import of electronic documents, as well as semi-automatic and manual import of hard and soft documents.

Matching Engine

Example embodiments of the present invention may include configurable business logic that allows for the comparison of customer deal/contract, schedule, change order, traffic instruction, affiliate lineup, and detection data from the ConfirMedia® monitoring network, or similar networks, to each other in various combinations, as well as to third party program, station and audience ratings data for the purpose of identifying discrepancies requiring resolution and/or reconciliation.

Data Warehouse

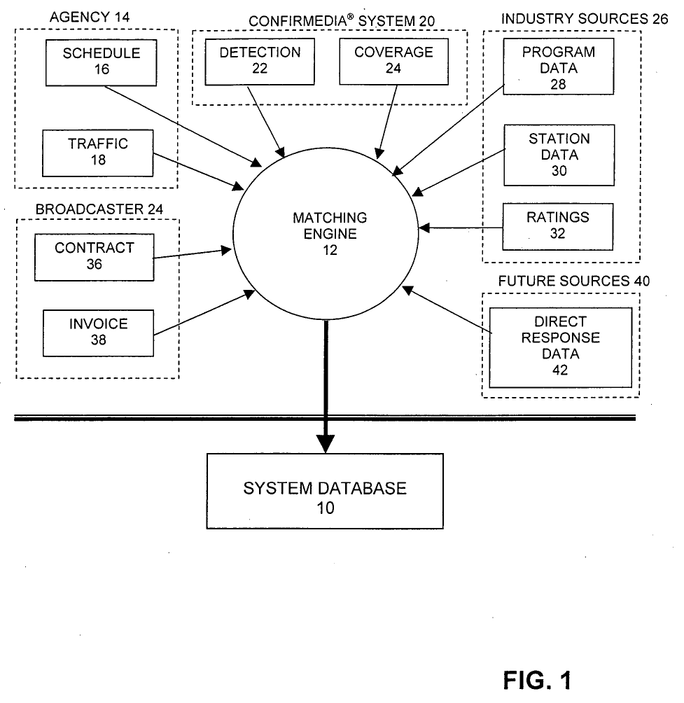

Example embodiments of the present invention may provide a secure ‘data warehouse’ environment in which users may query permissioned data and matching results for analysis that is specific to their account and their own individual user data permissions. FIG. 1 shows a simplistic block diagram of an example embodiment of the present invention, and provides a visual representation of the various sources and types of data imported into the Online system database 10 and available for comparison in various combinations by the Matching Engine 12 in order to generate various sets of Matching Analysis data for advertiser/agency and broadcaster customers. For example, as shown in FIG. 1, an Agency 14 may provide schedule information 16 and traffic information 18 to the matching engine 12 and/or the system database 10. The ConfirMedia® Data Management System 20 may provide detection information 22 and coverage information 24 to the matching engine 12 and/or the system database 10. The coverage information 24 provides information related to the extent of the broadcast monitoring network coverage (e.g., which radio, television, and Internet broadcast channels are actively monitored). Industry sources 26 may provide information such as program data 28 (e.g., TV and radio programming schedules from Tribune Media Services), station data 30 (e.g., station call signs, names and broadcast frequencies from BIA Financial database), or ratings information 32 (e.g., radio and television ratings from Arbitron and Nielson Media Research) to the matching engine 12 and/or the system database 10. Broadcaster 34 may provide contract information 36 and invoice information 38 the matching engine 12 and/or the system database 10. In addition, the example embodiment of FIG. 1 may incorporate future sources 40 such as direct response information 42 to the matching engine 12 and/or the system database 10. For example, the direct response information 42 may be used to assess the success of a direct response campaign (e.g., an infomercial that is being broadcast in a local market) by comparing the received customer purchase orders against the detected airplay instances of the direct response program. This information may be further used to refine the campaign operations by for example, increasing the frequency of broadcasts.

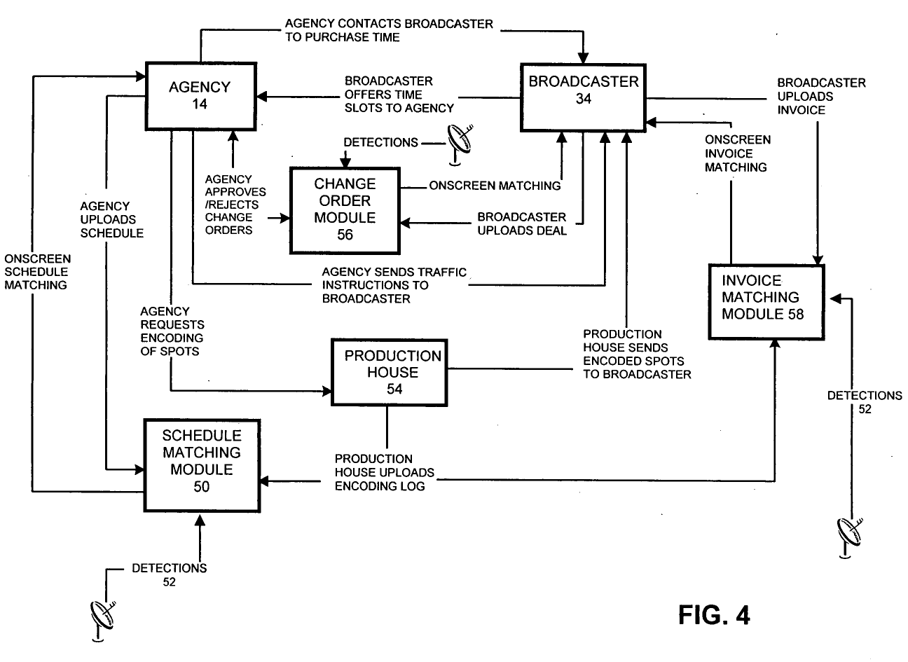

Those skilled in the art should appreciate that the example shown in FIG. 1 is a simplistic version of an example embodiment of the present invention provided for ease of explanation. For example, it should be appreciated that the system database 10 may comprise a plurality of databases at disparate locations, a plurality of databases at a single location, a segmented database, or a plurality of segmented databases. Further, the matching engine 12 may comprise separate modules for matching schedule information, for matching invoice information, and for matching change orders to contracts or contract revisions, as will be explained in more detail in connection with FIG. 4 below.

ConfirMedia Online Evolution

The original ConfirMedia® product line (an example of which is described in commonly owned United States Patent Application Publication US 2004/0073916 A1) continues to consist of a series of offline detection data reports, in various formats, which are made available to customers in a variety of ways for their own internal analysis, conducted within their own internal systems, including any comparative analyses against any other internal data.

The present invention also introduces an Internet based interface for importation of a wide range of customer broadcast advertising data into a centralized data warehouse environment, for the purposes of performing complex comparisons between the various sets of data and providing interactive and online analysis, dispositioning and reconciliation capabilities to both broadcaster and agency users based on the results of those comparisons including:
Automated and manual importation of customer Agency Schedule, Broadcaster Deal/Contract, Network Affiliate Lineup, Change Order, Agency Traffic Instructions, and Broadcaster Invoice data; as well as ConfirMedia® detection, monitoring and outage data; and 3^{rd} party program, broadcaster and audience delivery/ratings data.
Onscreen, exportable results of Agency Schedule vs. Detections data comparisons and matching, comprising:
   Summary counts of the numbers of resulting Ordered/Not Run (units on the Agency Schedule with no corresponding detection to verify its airing); Partially Matched (units on the Agency Schedule with a corresponding detection that only partially matches the details on the schedule); Matched (units on the Agency Schedule with a perfectly corresponding detection to verify its airing); and Unmatched Detections (additional detections, after all of the other possible schedule/detection matches have been made, with no corresponding unit on the Agency Schedule) matches, summarized by each agency/advertiser/brand-product/estimate#/market/broadcaster combination; and
   Detailed, side-by-side displays of the detailed data from each line of the Agency Schedule and/or the ConfirMedia® Detection Data for each of the four resulting match types described above represented in the summary display.
Onscreen, exportable results of Network/Syndicated Commercial Clearance data comparisons and matching, comprising:
   The number of expected individual affiliate airings/detections expected of each network radio, network television and/or syndicated television spot on the Agency Schedule, based on the number of affiliate stations defined on the network-/syndicator-provided lineup for each program during which each spot on the schedule is to air;
   Summary counts of the numbers of resulting Not Cleared (expected affiliate airings for each scheduled network or syndicated unit on the Agency Schedule with no corresponding detections); Partially Cleared (expected affiliate airings for each scheduled network or syndicated unit on the Agency Schedule with a corresponding detection that only partially matches the details on the schedule); Cleared (expected affiliate airings for each scheduled network or syndicated unit on the Agency Schedule with perfectly corresponding detections verifying its airing); and Unscheduled Airings (Additional detections, after all of the other possible schedule/detection matches have been made, with no corresponding expected affiliate airing on the lineup for the program on the Agency Schedule) matches, summarized for each network radio, network television or syndicated television unit on the Agency Schedule; and
   Detailed, side-by-side displays of the detailed data from each network radio, network television and/or syndicated television line of the Agency Schedule (supplemented by the corresponding Lineup data) and/or the ConfirMedia® Detection Data for each of the four resulting match types described above represented in the summary display for each affiliate on the lineup for each program on the Agency Schedule.
System capabilities allowing permissioned broadcaster users to generate and submit online Change Orders to specific permissioned agency customers for approval or rejection, based on individual units added to and/or removed from the Broadcaster Deal/Contract data (which are also verified by ConfirMedia® Detection data) as identified by comparisons of iterative versions of the data imported into the system in accordance with an example embodiment of the present invention.
System capabilities for generating onscreen and automated email notifications to agency and broadcaster users of instances where specific commercials are airing outside the parameters defined in the Agency Schedule and the Agency Traffic Instructions;
Onscreen, exportable results of Broadcaster Invoices vs. Detections data comparisons and matching, comprising:
   Summary counts of the numbers of resulting On Invoice/No Match (units on the Broadcaster Invoice with no corresponding detection to verify its airing); Matched (units on the Broadcaster Invoice with a perfectly corresponding detection to verify its airing); and Unmatched Detections (Additional detections, after all of the other possible invoice/detection matches have been made, with no corresponding unit on the Broadcaster Invoice) matches, summarized by each agency/advertiser/brand-product/invoice#/market/broadcaster combination; and
   Detailed, side-by-side displays of the detailed data from each line of the Broadcaster Invoice and/or the detection data for each of the three resulting match types described above represented in the summary display;
Onscreen, exportable results of Network/Syndicated Program Clearance data comparisons and matching, comprising:
   The number of expected individual affiliate airings/detections expected of each network radio, network television and/or syndicated television program on the network-/syndicator-provided lineup for each program;
   Summary counts of the numbers of resulting Not Cleared (expected affiliate airings for each network or syndicated program, based on the Affiliate Lineup, with no corresponding detections); Partially Cleared (expected affiliate airings for each network or syndicated program, based on the Affiliate Lineup, with a corresponding detection that only partially matches the details on the lineup); Cleared (expected affiliate airings for each network or syndicated program, based on the Affiliate Lineup, with perfectly corresponding detections verifying its airing); and Unscheduled Airings (Additional detections, after all of the other possible lineup/detection matches have been made, with no corresponding expected affiliate airing on the lineup for the program) matches, summarized for each network radio, network television or syndicated television program; and
   Detailed, side-by-side displays of the detailed data from each network radio, network television and/or syndicated television program, based on the Affiliate Lineup, and/or the ConfirMedia® Detection Data for each of the four resulting match types described above represented in the summary display for each affiliate on the lineup for each program.
      Example Features and Functionalities Provided By Example Embodiments of the Present Invention
      Data Security

Advertisers demand that agencies maintain high levels of confidentiality regarding their advertising plans, programs and expenditures. Agency Schedule data contains detailed information that no advertiser would ever allow their competitors to see. Likewise, broadcast advertising rates are aggressively negotiated, and broadcasters would never allow one advertiser or agency to see the rates other advertisers and agencies have negotiated for similar airtime, which are all included in Agency Schedule data, Broadcaster Deal/Contract data, Change Order data, and Broadcaster Invoice data. Consequently, advertisers and their agencies, and broadcasters, all place a very high priority on data security and the prevention of unauthorized access to this proprietary data that they maintain confidentially in their respective internal systems. Before agreeing to become a customer and to start exporting this confidential data out of their internal systems and into a system in accordance with the present invention, advertisers, their agencies and broadcasters would all demand assurances regarding the security of their data and the prevention of unauthorized access.

Example embodiments of the present invention provide three levels of data security permissioning:

I. Account-level

II. Customer administrator-level

III. User-level.

I. Account-Level Security & Permissions

No users can access the inventive system without first being associated with an existing Online account, and being provided a system-generated username and password to access that account and the corresponding data associated with it.

Online accounts can only be established by designated database system administrators, and only at the direction of management staff from the customer support department.

Database system administrators can set up two types of Online accounts:
Agency accounts; and
Broadcaster accounts.

In setting up an agency account, system administrators may input customer-provided lists of advertisers and advertisers' brands/products to be associated with that agency. The Online system provided in accordance with an example embodiment of the present invention then allows users on agency accounts to only access data associated with that agency and with those advertisers and those advertisers' brands/products. The Online system does not allow users on one agency account to access data associated with other agency accounts or with advertisers and advertisers' brands/products associated with other agency accounts. The Online system allows users on agency accounts to access data associated with their own agency and with the advertisers and advertisers' brands/products associated with their own agency across all broadcasters.

In setting up a broadcaster account, system administrators may input customer-provided lists of markets and networks/stations to be associated with that broadcaster. The Online system provided in accordance with an example embodiment of the present invention allows users on broadcaster accounts to only access data associated with advertising airing or scheduled to air on network or stations associated with that broadcaster but does not allow users on one broadcaster account to access data associated with advertising airing or scheduled to air on another broadcaster's networks or stations. The Online system may also allow users on broadcaster accounts to access data associated with advertising for all agencies and advertisers airing or scheduled to air on that broadcaster's network or stations.

System administrators may also permission agency and broadcaster accounts to have access to data based on media type (local cable, national cable, network radio, network television, spot radio, spot television, and/or syndicated television). Agency accounts are typically (but not always) permissioned for access to data associated with all media types, as agencies typically purchase advertising airtime on behalf of their advertising clients on all media types. Broadcaster accounts are typically (but not always) permissioned for access to data associated with only specific media types. It would be inappropriate, for example, to permission a network radio broadcaster account to have access to data associated with national cable advertising, assuming that network radio broadcaster owned no national cable network properties.

System administrators may also permission agency and broadcaster accounts to have access to data based on market and broadcaster values associated with each permissioned media type. Agency accounts are typically (but not always) permissioned for access to data associated with all markets and broadcasters associated with each media type, as agencies typically have the flexibility to purchase advertising airtime on behalf of their advertising clients on all broadcasters in all markets associated with all media types. Broadcaster accounts are typically (but not always) permissioned for access to data associated with only specific networks or only with stations within specific markets associated with the permissioned media types for that broadcaster. It would be inappropriate, for example, to permission a spot television broadcaster account that only has stations in New York and Los Angeles to have access to data associated with advertising on other stations in other markets since that spot television broadcaster owned no other stations in any other markets.

Account types and account-level permissions also drive user access to certain system features and functionality. Some example comprise:
Only users on broadcaster accounts can import Broadcaster Deal/Contract, Affiliate Lineup or Broadcaster Invoice data into the Online system; and only users on agency accounts can import Agency Schedule or Agency Traffic Instructions data into the Online system;
Only users on broadcaster accounts can create Change Orders from their Deal/Contract data, and submit them to an agency user for approval or rejection; and only users on agency accounts can receive Change Orders from broadcasters and approve or reject them;
Only users on agency accounts can forward selected alerts regarding spots airing incorrectly on particular broadcasters to those broadcasters for resolution.

System administrators may also input customer-provided information from management staff from a customer support department regarding the name(s) and location(s) of one or more company and/or company office to be associated with the agency or broadcaster account, allowing customer administrative users to be able to assign individual customer users to specific companies and/or office locations.

System administrators may also establish one or more Administrator (also Admin) user account on each company account, again based on customer-provided input from management staff from the customer support department.

II. Customer Administrator-Level Security & Permissions

As described above, system administrators may establish one or more customer administrator-level user account on each agency and each broadcaster company account. The primary responsibility of a customer administrator is to establish individual user accounts for, and assign specific permissions to, all users that are to be allowed access to their company's Online account.

Example embodiments of the Online system of the present invention provide administrators on each agency and each broadcaster account onscreen tools to establish these individual user accounts on their respective company accounts, and to assign and manage specific data access permissions to each user on their company's account.

The Admin module of the Online system may only be available to users on agency and broadcaster company accounts that have been assigned administrative permissions and privileges by a system administrator at the request of management staff from the customer support department. To access these features and functionality, an Admin link that is visible and available only to users with these customer administrator permissions displays on the main system navigation bar, which is described in detail later in this document.

Customer account administrators input basic information about each user to be added to their company's account into free-form onscreen text fields, comprising:
First name
Last name
Email address
Telephone number
Company name and location (selected from a drop down list of the customer-provided values supplied by the customer support department and input for each account by system administrators at the time the account was established).

The Online system may also provide administrators on each agency and each broadcaster account onscreen tools to assign specific data access permissions to each individual user on their company's account, including permissions based on:
Agency (A permissioning option on broadcaster accounts only, as agency accounts, by definition, are associated with only one agency. Permissions for users on broadcaster accounts are selected from a checkbox list of Online customer agencies supplied by the customer support department and input by system administrators at the time each agency account is established);
Advertiser (selected from a checkbox list of the customer-provided values supplied by the customer support department and input for each agency account by system administrators at the time each agency account is established);
Brands/Products (selected from a checkbox list of the customer-provided values supplied by the customer support department and input for each agency account by system administrators at the time the agency account is established);
Media Type (selected from a checkbox list of the media type values supplied by the customer support department and input for each account by system administrators at the time the each agency or broadcaster account is established);
Market (selected from a checkbox list of all TV or radio markets associated with the media types selected for agency accounts; and from a checkbox list of the media type values supplied by the customer support department and input for each broadcaster account by system administrators at the time the each broadcaster account is established);
Broadcaster (A permissioning option on broadcaster accounts only, as agency users typically have access to data for all broadcasters in any market they are permissioned for. Permissions for users on broadcaster accounts are selected from a checkbox list of networks and/or stations supplied by the customer support department and input by system administrators at the time each broadcaster account is established).

Since, as described below, the Online Traffic module provided in accordance with an example embodiment of the present invention provides functionality that most agency and broadcaster accounts would only want to extend to specific users on their respective accounts, the Online system provides administrators on each agency and each broadcaster account onscreen radio buttons to assign specific traffic feature access privileges to each individual user on their company's account as either:
View/set/clear (Specific users privileged to set traffic alert settings, and clear uncleared alerts, as defined below); or
View-only (Users privileged only to view traffic alert settings and alert data, but not privileged to set alert settings or clear uncleared alerts, as defined below).

The Online system may provide administrators access to all data and all features permissioned to their respective account, primarily in order for them to be able to troubleshoot issues with any of the data or with any of the features any of the users on the account may encounter.

The Online system may provide administrators on each agency and each broadcaster account an onscreen summary of key information regarding all of the users associated with their account, displayed in an onscreen panel with, for example, the following column headers:
First and last name;
Phone number;
Email address
Company name;
Company location;
Role (User or Administrator); and
Username (System-generated, based on first name initial and last name; Required for login).

By clicking on any of the column headers described above, the Online system allows administrators on each agency and each broadcaster account to sort and re-sort the onscreen data summarizing all of the current customer users associated with the company's account based upon any of the values described above; and to easily return the user summary data onscreen to its original default sort/display order.

The Online system may also provide administrators on each agency and each broadcaster account onscreen links and buttons to:
View and/or edit previously submitted information for each user, comprising:
   First name
   Last name
   Phone number
   Email address
   Company name
   Company location.
View and/or edit previously submitted data access permissions for each user, comprising:
   Agency(s) (broadcaster users only);
   Advertiser(s)
   Brand(s)/Product(s)
   Media Type(s)
   Market(s)
   Broadcaster(s) (broadcaster users only).
Remove existing users from their account, there by discontinuing the removed user's access to the system and any of its features, as well as any of the account's data in the system.
Re-set a user's password upon request, either for security purposes or if a user has forgotten and/or misplaced their password.

The Online system may also allow administrators on each agency and each broadcaster account to view and/or edit their own user information, comprising:
First name
Last name
Phone number
Email address
Company name
Company location.

For security purposes, a customer administrator on an agency or a broadcaster account may only be added or removed from that account by a system administrator.

For security purposes, a password for a customer administrator on an agency or a broadcaster account may only be re-set by a system administrator.

The Online system may also provide administrators on each agency account onscreen tools to aggregate and associate various brand(s)/product(s) into product groups for more streamlined data display and to be more consistent with the organization of their client data in their internal agency systems. For example, an auto manufacturer advertiser has several different models that are considered brands/products from a marketing or advertising perspective. Typically, it is more efficient to advertise and/or analyze data for those brands/products in logical groupings, often referred to in the auto manufacturing industry as divisions, based either on nameplate or vehicle type (i.e. cars vs. trucks) etc.

Another example of the configurability the Online system the ability for customer administrators on each agency and each broadcaster account to set various thresholds for allowable variances in times for matching a detection to a schedule line. For example, some advertisers may require that all of their spots air exactly within the precise start and end time of a particular program or a defined time range on all broadcasters, in which case the administrator for that account would establish the time matching threshold for those advertisers associated with their account at plus-or-minus zero minutes allowable variation from the scheduled start/end time. While other advertisers are content if their spots actually air in the commercial breaks leading into or out of a program, in which case the administrator for that account would establish the time matching threshold for those advertisers associated with their account at plus-or-minus two or even three minutes allowable variation from the scheduled start/end time.

As described below, broadcaster accounts may only receive auto-email notifications of new traffic instructions uploads and new traffic alerts from the Online traffic module on a centralized account (as opposed to user-specific) basis. For this reason, the system may provide administrators on each broadcaster account an onscreen tool to designate a single individual user on their account as the central recipient of all system-generated traffic auto-email notifications, with the understanding that that user will in turn forward each one to the appropriate recipient in the company.

The Online system may provide customer administrators relevant onscreen assistance and feedback for each feature in the form of a prompt text bar at the top of each screen.

III. Customer User-Level Security & Permissions

As described earlier in this section, data security and access is an important consideration in the present invention. It is important to customers that user access to data imported into and maintained within the Online system be strictly controlled based on the complex combinations and levels of user permissioning described above.

Most importantly, the Online system does not allow individual customer users access to the system or to any of the data contained in the system without first being associated with either an active, existing Online advertiser/agency account or broadcaster account, and assigned a series of required data access permissions based on account company type, agency, advertiser, brand/product, media type, market, and broadcaster values, by an authorized customer administrator for that account.

Upon association with an active, existing Online advertiser/agency or broadcaster account or broadcaster account by an authorized customer administrator for that account, the Online system may generate and send an auto-email notification to the email address for the new customer use that was entered into the system by the customer administrator for that user. This auto-email notification may:
Inform the new customer user that they have been added to a specific Online account;
Provide a system-generated username for log in purposes (based on a combination of the first initial of the first name and the complete last name entered into the system by the customer administrator for that user);
Provide a system-generated temporary password for log in purposes; and
Provide direction for navigating to the main login screen and logging in.

The Online system may also provide all users with onscreen pre-login help including links on the pre-login navigation bar that display screens with information regarding:
How to have a new secure login password sent to their email address if they have forgotten or lost their existing password;
How to obtain their login username from their accounts customer administrator or from customer support if they have lost or forgotten their username; and
Complete contact information, including phone numbers, fax numbers, email address, street addressed and contact names for Online customer support as well as various regional field offices.

The first time a newly-established customer user logs into the Online system by navigating to the log in screen and entering their system-generated username and temporary password, the system recognizes that this is their first log in, and requires them to change their temporary password to one that will be more easily remembered by entering their temporary system-generated password and entering and submitting a new personalized on in onscreen free-form text entry fields.

For additional user-level security, each user's personalized password is never available to any other users, including customer account administrators or Online customer support staff or system/database administrator. If a user forgets their password, they can have it automatically re-set by navigating to the Login Help screen and entering their email address and username, which will initiate a new temporary system-generated password being emailed to them (which they will be required to change upon initial login). Or users can request their customer account administrator re-set their password by navigating to the user summary screen and clicking the re-set password button for that user, which will also initiate the process of having a new temporary password emailed to the user.

Upon each successful log in, the Online system may recognize the user logging in from their unique username/password combination, recognizing which agency or broadcaster company account they are associated with, and enforcing both the account-level and user-level data access and feature access permissions described earlier.

The Online system provides customer users relevant onscreen assistance and feedback for each feature in the form of a prompt text bar at the top of each screen.

Examples of Main Feature Navigation

The Online system may provide customer administrators and customer users access to various permissioned combinations of system features and functionality via a horizontal navigation bar on the initial screen displayed upon successful login.

In support of the data access and feature access security models described earlier, the navigation options available on the main navigation bar for each user depend upon the type of user the system recognized them to be upon login (customer administrator or customer user); the type of company account the system recognized the user as being associated with upon login (agency account or broadcaster account); as well as all of the individual user permissions previously and currently assigned to that user by a customer administrator on that account, including permissions based upon agency, advertiser, brand/product, media type, market, and broadcaster data values, as well as whether the user has been assigned View/set clear or View only traffic privileges.

Examples of main navigation options available to various users may include, but not be limited to:

1. Import: Since various Online Import features and functionality may be available to all users of the system, regardless of company account type, user type or user permissions, the navigation link to the Online Import features and functionality is visible and available on the main navigation bar to all users;

2. Data Matching: Since various Online Data Matching features and functionality may be available to all users of the system, regardless of company account type, user type or user permissions, the navigation link to the Online Data Matching features and functionality is visible and available on the main navigation bar to all users;

3. Change Orders: Since various Online Change Orders features and functionality may be available to all users of the system, regardless of company account type, user type or user permissions, the navigation link to the Online Change Orders features and functionality is visible and available on the main navigation bar to all users;

4. Traffic: Based on initial perceived market demand, the Online Traffic module may provide functionality supporting broadcast advertising traffic for the three media types of national cable, spot radio and spot television, with the flexibility to extend the functionality to additional media types, including local cable, network radio, network television and syndicated television. Consequently, the Traffic link on the main Online navigation bar may be only visible and available to accounts, and to users on accounts, permissioned for at least one of those three initial media types: e.g., national cable, spot radio and/or spot television;

5. Admin: Since the Online Customer Administration features and functionality may be available only to users on agency and broadcaster accounts permissioned to be administrators on those accounts by a system administrator, the navigation link to the Online Admin features and functionality is visible and available on the main navigation bar only to users with those customer administrator permissions;

6. Logoff: Since the Online Logoff feature may be available to all users of the system, regardless of company account type, user type or user permissions, the navigation link logging users off of the system and re-displaying the initial login screen is visible and available on the main navigation bar to all users.

Online Import Functionality

The Online import functionality allows users on agency and broadcaster accounts to export selected proprietary data from their respective internal systems into the Online system for comparative analysis against other data in the system.

Since various Online import features and functionality may be available to all users of the system, regardless of company account type, user type or user permissions, the navigation link to the Online import features and functionality is visible and available on the main navigation bar to all users.

Clicking on the Import link on the main Online feature navigation bar may display the initial import screen, which provides customer administrators and customer users onscreen tools to:
Browse to, select and upload specific types of industry data files saved to their internal network directories from their internal systems into the Online system; and
Query and display a summary of user-selected types of files previously imported into the Online system during a user-specified date range.

Based on the type of company account the logged in user is associated with, the onscreen import tools may allow users on agency accounts and users on broadcaster accounts to upload various types of data files into the Online system.

Agency User Imports

The Online system may provide customer administrators and customer users on agency company accounts onscreen tools to upload the following types of data files into the Online system by selecting from a drop down list of import type options for agency users:
Agency Schedules: Since Agency Schedule data files are created and maintained in an agency's internal media management system, and can only be accessed by agency staff, all customer administrators and customer users on Online agency accounts have access to onscreen tools to upload Agency Schedule data files for their account into the Online system;
Agency Traffic Instructions: The Online Traffic module may provide functionality supporting broadcast advertising traffic for the three media types of national cable, spot radio and spot television. And, since Agency Traffic Instructions data files are created and maintained in an agency's internal traffic system, and can only be accessed by agency staff, all customer administrators and customer users on Online agency accounts permissioned for the national cable, spot radio and/or spot television media types are have access to onscreen tools to upload Agency Traffic Instructions data files for their account into the Online system;
   Broadcaster User Imports

The Online system provides customer administrators and customer users on broadcaster company accounts onscreen tools to upload the following types of data files into the Online system by selecting from a drop down list of import type options for broadcaster users:
Broadcaster Deals/Contracts: Since Broadcaster Deal/Contract data files are created and maintained in a broadcaster's internal sales inventory management system, and can only be accessed by broadcaster staff, all customer administrators and customer users on Online broadcaster accounts have access to onscreen tools to upload Broadcaster Deal/Contract data files for their account into the Online system;
Broadcaster Invoices: Since Broadcaster Invoice data files are created and maintained in a broadcaster's internal finance system, and can only be accessed by broadcaster staff, all customer administrators and customer users on Online broadcaster accounts have access to onscreen tools to upload Broadcaster Invoice data files for their account into the Online system;
Affiliate Station Lineups: Since only network radio, network television and syndicated television broadcast advertising airs on multiple stations in multiple markets, Affiliate Station Lineup data is only relevant to network radio, network television and syndicated television broadcast advertising. And since Affiliate Station Lineup data files are created and maintained only in a network or syndicated broadcaster's affiliate relations management system, and can only be accessed by a network or syndicated broadcaster's staff, all customer administrators and customer users on Online broadcaster accounts permissioned for network radio, network television and/or syndicated television have access to onscreen tools to upload Affiliate Station Lineup data files for their account into the Online system.

To accommodate the various file formats in which all of the different types of broadcast advertising industry data files described above are likely to be uploaded to the Online system, (which file format is typically determined by the type of internal system in which the data was originally generated and from which it is being exported), the Online system has been configured to take in each data type in as many of the known common data file formats as possible, and provides users onscreen tools to be able to select from a drop down list of format types based on the import type selection described above, and export the data from their internal systems into the Online system in the appropriate respective formats.

Additionally, to accommodate data files in formats not able to be uploaded into the Online system on a fully automated basis using the onscreen tools in the Import module, offline data file transformations may be created that allow the data to be uploaded into the system on a semi-automated basis.

In order to ensure proper uploading of the various types of customer broadcast advertising data into the Online system, the system may conduct extensive validation processes on each file uploaded to the system, as well as all of the data contained in each file, including, for example, validation:
That the format of the file name is consistent with the standard format of each file type;
That the file name extension matches the file format type the user identified onscreen as part of the import process;
That all of the required fields for each record within the file are present and populated with correctly formatted data; and
In some instances, that values in certain required fields are recognized by the system as being valid values for that field for that particular account, such as the agency name, advertiser name and brand/product name values associated with that account by the system administrator at the time the account was established.

To ensure the importation of valid data, the system may also provide users with onscreen and emailed input as to the success or failure of all attempted uploads and data validation. Additionally, Online customer support staff may receive detailed email information about specific data upload and validation failures, allowing them to troubleshoot failures by either correcting format errors and using onscreen tools to re-import and/or re-validate the failed file; and/or creating aliases in the database to which unrecognized values contained in otherwise valid files will be automatically mapped, including aliased values for agencies, advertisers, brands/products, mediums, media types, networks, and programs, as well as other values. For example, if ‘General Motors’ was an advertiser value set up in the system for a particular account, but an Agency Schedule was uploaded with ‘GM’ in the advertiser fields, the system would not recognize ‘GM’ as a valid advertiser value. In this case, the invalid value (‘GM’) would be included in a failed validation email to Online customer support, prompting them to work with the database system administrators to enter ‘GM’ into the database as an approved alias and map it to the original value of ‘General Motors’. From that point forward, any documents entered into the system with ‘GM’ as a value in the advertiser field will be validated as valid ‘General Motors’ advertising data and associated with all of the ‘General Motors’ advertising data in the system. The Online system may also provide customer support staff with onscreen tools to re-validate the new file so that the records containing the newly aliased values can be parsed into the Online database and become eligible for matching to other corresponding data in the system without having to be removed and re-uploaded.

Since various files are often generated in customers' internal systems cumulatively over varying periods of time, the Online system may also provide users onscreen tools for directing the system as to how to handle new files with overlapping data. For example, if a new file is being uploaded, and the system recognizes that it overlaps dates with another file for the same agency, advertiser and brand/product, the system provides tools to indicate whether the data in the new file should completely overwrite and replace the entire original file, or if only the portions of data in the new file that overlap portions of data in the original file with the same dates should be replaced, leaving the non-overlapping dates in the original file in place and active within the system.

Depending on the perceived relative importance placed by a customer on how current the matching results for a particular type of data must be, all data uploaded to the Online system may be either immediately matched to other existing data in the system, or queued up for matching on a nightly, overnight basis, with results being available the following morning.

For example, the successful importation of Agency Schedule or Broadcaster Invoice data may automatically initiate system matching (including re-matching of previously matched related data) based on the newly imported data. However, successfully imported Agency Traffic Instructions data may not initiate any immediate matching or re-matching, and may instead be queued up to be matched to other relevant data in the system on a scheduled, overnight basis, with results becoming available to permissioned users the following morning.

In order to keep customers and Online customer support staff informed of the status of that data in the system upon which all matching results are based, the system may provide auto-email notification of the success or failure of immediate and overnight matching of each file in the system, with Online customer support staff having additional onscreen tools to manually rematch, revalidate and/or remove specific files and their corresponding data from the system.

For reference and/or troubleshooting purposes, the Online system may also provide users onscreen tools with which to query and display fully sortable, historical summaries of previous file uploads, including:
The date and time the file was uploaded;
The file name;
The agency, advertiser and brand/product associated with the file;
Corresponding file ID's, such as estimate number for Agency Schedule data, invoice number for Broadcaster Invoice data etc.;

The active date range of the data contained in the file;
A Online system-generated upload ID number and import status information, as well as the date the data in the file was last matched to other data in the system, all to assist with troubleshooting the upload.
The Online system may provide users relevant onscreen assistance and feedback for each feature in the form of a prompt text bar at the top of each screen.
   Example Embodiment of Online Data Matching Functionality

The Online Data Matching module is anticipated to be the core area of functionality for most customer users, allowing them to query and display summary and detailed matching results from the comparisons of Agency Schedule and Broadcaster Invoice data against Detection data in order to be able to verify that all of the agreed upon advertising in the Agency Schedule aired and was billed correctly by the broadcaster; and to also be able to identify and rectify and reconcile any broadcast errors or changes. Similarly, the Online Data Matching module may also provide network and syndicated broadcasters with additional onscreen matching analysis tools to verify that affiliate stations in their respective radio and TV markets across the country are airing network and syndicated programming as contractually obligated by the terms of their affiliate agreement with the network and/or the syndicator.

Specifically, the Online Data Matching module may provide permissioned users onscreen drop down selection lists of the following exemplary primary data matching analysis feature options:

1. Agency Schedule vs. Detections: The ability to query, display and export onscreen results of an Agency Schedule to Detections match (comparisons of Agency Schedule data and associated Detection data), including:

Summary counts of the resulting numbers of Ordered/Not Run (units on the Agency Schedule with no corresponding detection to verify its airing); Partially Matched (units on the Agency Schedule with a corresponding detection that only partially matches the details on the schedule); Matched (units on the Agency Schedule with a perfectly corresponding detection to verify its airing); and Unmatched Detections (Additional detections, after all of the other possible schedule/detection matches have been made, with no corresponding unit on the Agency Schedule) matches, summarized by each agency/advertiser/brand-product/estimate#/market/broadcaster combination; and
Detailed, side-by-side displays of the detailed data from each line of the Agency Schedule and/or the Detection Data for each of the four resulting match types described above represented in the summary display;

2. Broadcaster Invoices vs. Detections: The ability to query, display and export onscreen results of a Broadcaster Invoice to Detections match (comparisons of Broadcaster Invoice data and associated Detection data), including:

Summary counts of the resulting On Invoice/No Match (units on the Broadcaster Invoice with no corresponding detection to verify its airing); Matched (units on the Broadcaster Invoice with a perfectly corresponding detection to verify its airing); and Unmatched Detections (Additional detections, after all of the other possible invoice/detection matches have been made, with no corresponding unit on the Broadcaster Invoice) matches, summarized by each agency/advertiser/brand-product/invoice#/market/broadcaster combination; and
Detailed, side-by-side displays of the detailed data from each line of the Broadcaster Invoice and/or the Detection Data for each of the three resulting match types described above represented in the summary display;

3. Network & Syndicated Commercial Clearance: The ability to query, display and export onscreen results of an Agency Schedule supplemented with Network Affiliate or Syndicated Station Lineup data to Detections match, (comparisons of Agency Schedule data that has been supplemented with Network Affiliate or Syndicated Station Lineup data, and associated Detection data specifically for network radio, network television and syndicated television advertising), including:

The number of expected individual affiliate airings/detections expected of each network radio, network television and/or syndicated television spot on the Agency Schedule, based on the number of affiliate stations defined on the network-/syndicator-provided lineup for each program during which each spot on the schedule is to air;
Summary counts of the resulting Not Cleared (expected affiliate airings for each scheduled network or syndicated unit on the Agency Schedule with no corresponding detections); Partially Cleared (expected affiliate airings for each scheduled network or syndicated unit on the Agency Schedule with a corresponding detection that only partially matches the details on the schedule); Cleared (expected affiliate airings for each scheduled network or syndicated unit on the Agency Schedule with perfectly corresponding detections verifying its airing); and Unscheduled Airings (additional detections, after all of the other possible schedule/detection matches have been made, with no corresponding expected affiliate airing on the lineup for the program on the Agency Schedule) matches, summarized for each network radio, network television or syndicated television unit on the Agency Schedule; and
Detailed, side-by-side displays of the detailed data from each network radio, network television and/or syndicated television line of the Agency Schedule (supplemented by the corresponding Lineup data) and/or the Detection Data for each of the four resulting match types described above represented in the summary display for each affiliate on the lineup for each program on the Agency Schedule.

4. Network & Syndicated Program Clearance: The ability to query, display and export onscreen results of a Broadcaster Program Schedule to Detections match, (comparisons of Network Affiliate Lineup data and associated Detection data for network radio, network television and syndicated television programming), including:

The number of expected individual affiliate airings/detections expected of each network radio, network television and/or syndicated television program based on the number of affiliate stations defined on the network-/syndicator-provided lineup for each program;
Summary counts of the resulting Not Cleared (expected affiliate airings for each scheduled network or syndicated program with no corresponding detections); Partially Cleared (expected affiliate airings for each scheduled network or syndicated program with a corresponding detection that only partially matches the details on the schedule); Cleared (expected affiliate airings for each scheduled network or syndicated program with perfectly corresponding detections verifying its airing); and UnscheduledAirings (additional detections, after all of the other possible affiliate lineup/detection matches have been made, with no corresponding expected affiliate airing on the lineup for the program) matches, summarized for each network radio, network television or syndicated television program; and
Detailed, side-by-side displays of the detailed data for each Affiliate Lineup for each network radio, network television and/or syndicated television program and/or the detection data for each of the four resulting match types described above represented in the summary display for each affiliate on the lineup for each program.

The Online Data Matching module may provide users the onscreen ability to query and display matching results data for the data matching analysis features described above by permissioned media type, with each user's onscreen drop down selection list of filter options based upon specific account and individual user permissions.

The Online Data Matching module may also provide users the onscreen ability to further filter and display data matching results by selecting from various combinations of relevant onscreen drop down selection filters for each data matching analysis type, including but not limited to:
Agency (Relevant for all four Data Matching analysis types)
Advertiser (Relevant for all four Data Matching analysis types)
Product group (Relevant for Agency Schedule vs. Detections matching only)
Brand/product (Relevant for all four Data Matching analysis types)
Estimate # (Relevant for Agency Schedule vs. Detections and Network & Syndicated Commercial Clearance matching only)
Invoice # (Relevant for Broadcaster Invoices vs. Detections matching only)
Market (Relevant for all four Data Matching analysis types)
Broadcaster (Relevant for all four Data Matching analysis types)
Network (Relevant for Network & Syndicated Commercial Clearance and Network & Syndicated Program Clearance matching only)
Program (Relevant for Network & Syndicated Commercial Clearance and Network & Syndicated Program Clearance matching only)
Segment (Relevant for Network & Syndicated Program Clearance matching only)
Daypart (Relevant for Agency Schedule vs. Detections and Network & Syndicated Commercial Clearance matching only)
Spot Length (Relevant for Agency Schedule vs. Detections and Network & Syndicated Commercial Clearance matching only)
Match Type (Relevant for all four Data Matching analysis types)
Date Range (Relevant for all four Data Matching analysis types)

Estimate numbers are used primarily internally by agencies to group advertising expenditures for accounting purposes, similar to the way purchase order numbers and other budgeting codes are used in other industries. To provide maximum flexibility, and to be consistent with standard industry practices, the Online system may also allow users the option of further filtering and displaying Agency Schedule vs. Detections and Network Commercial Clearance matching data by estimate number.

Invoice numbers are used by broadcasters to identify each advertiser's monthly billings for accounting purposes. To provide maximum flexibility, and to be consistent with standard industry practices, the Online system may also allow users the option of further filtering and displaying Broadcaster Invoices vs. Detections matching data by invoice number.

To streamline the onscreen data filter selection process, the Online system may provide users with onscreen free-form text entry boxes and submission buttons with which to name, save, modify and/or delete frequently used sets of data matching data filters for future single-click selection. The system also allows users to easily clear/re-set all data matching filter selections back to the system default options with a single button click.

In one example embodiment, selecting a permissioned media type; selecting the Broadcaster Invoices vs. Detections matching analysis type; and selecting the desired permissioned data matching analysis results filters as described above, and clicking a ‘Go’ button, displays a fully sortable summary panel of permissioned invoice vs. detections matching results. The Broadcaster Invoices vs. Detections Summary panel displays counts for each of the three match types described below for each agency/advertiser/brand-product/market/broadcaster/invoice number (if display option checked) combination:
On Invoices/No Match: Units on the Broadcaster Invoice with no corresponding detection to verify its airing;
Matched: Units on the Broadcaster Invoice with a perfectly corresponding detection to verify its airing
Unmatched Detections: Additional detections, after all of the other possible invoice/detection matches have been made, with no corresponding unit on the Broadcaster Invoice.

In a further example embodiment, selecting a permissioned media type; selecting the Agency Schedule vs. Detections matching analysis type; and selecting the desired permissioned data matching analysis results filters as described above, and clicking a ‘Go’ button, displays a fully sortable summary panel of permissioned schedule vs. detections matching results. The Agency Schedule vs. Detections Summary panel displays counts for each of the four match types described below for each agency/advertiser/brand-product/market/broadcaster/estimate # (if display option checked) combination:
Ordered/Not Run: Units on the Agency Schedule with no corresponding detection to verify its airing;
Partially Matched: Units on the Agency Schedule with a corresponding detection that only partially matches the details on the schedule;
Matched: Units on the Agency Schedule with a perfectly corresponding detection to verify its airing
Unmatched Detections: Additional detections, after all of the other possible schedule/detection matches have been made, with no corresponding unit on the Agency Schedule.

In a further example embodiment, selecting a permissioned network or syndicated media type; selecting the Commercial Clearance matching analysis type; and selecting the desired permissioned data matching analysis results filters as described above, and clicking a ‘Go’ button, displays a fully sortable summary panel of permissioned schedule/lineup vs. detections matching results. The Commercial Clearance Summary panel displays counts for each of the four match types described below for each agency/advertiser/brand-product/network/program/estimate number (if display option checked)/date/spot code combination summarized for each network radio, network television or syndicated television unit on the Agency Schedule:
Not Cleared: Expected affiliate airings for each scheduled network or syndicated unit on the Agency Schedule with no corresponding detections;
Partially Cleared: Expected affiliate airings for each scheduled network or syndicated unit on the Agency Schedule with a corresponding detection that only partially matches the details on the schedule
Cleared: Expected affiliate airings for each scheduled network or syndicated unit on the Agency Schedule with perfectly corresponding detections verifying its airing; and
Unscheduled Airing: Additional detections, after all of the other possible schedule/detection matches have been made, with no corresponding expected affiliate airing on the lineup for the program on the Agency Schedule.

In another example embodiment, selecting a permissioned network or syndicated media type; selecting the Program Clearance matching analysis type; and selecting the desired permissioned data matching analysis results filters as described above, and clicking a ‘Go’ button, displays a fully sortable summary panel of permissioned program lineup vs. detections matching results. The Program Clearance Summary panel displays counts for each of the four match types described below for each network radio, network television or syndicated television program:
Not Cleared: Expected affiliate airings for each scheduled network or syndicated program with no corresponding detections;
Partially Cleared: Expected affiliate airings for each scheduled network or syndicated program with a corresponding detection that only partially matches the details on the schedule;
Cleared: expected affiliate airings for each scheduled network or syndicated program with perfectly corresponding detections verifying its airing; and
Unscheduled Airing: Additional detections, after all of the other possible affiliate lineup/detection matches have been made, with no corresponding expected affiliate airing on the lineup for the program

In order to provide permissioned users with as complete of a data matching analysis as possible, the Online system may provide an link to an onscreen display of unmonitored broadcasters that would otherwise have been included in the result set based on the selected data filters, but that are not or were not being monitored by the ConfirMedia® system during the filtered date range.

Summary panels for all of the matching analysis types described above may also include links allowing permissioned users to display detailed data for various sub-sets of match results represented in the summary table, depending on the selection made in the summary table, comprising:
Matches represented by counts in individual cells of the summary table which, for example for Agency Schedule vs. Detections matching would include all of the matches for one match type (such as ‘Ordered/Not Run’) for one agency/advertiser/brand-product/market/broadcaster combination;
Matches represented by total counts in each of the match type columns in each summary table which, for example for Agency Schedule vs. Detections matching would include all of the matches for one match type (such as ‘Ordered/Not Run’) for all of the agency/advertiser/brand-product/market/broadcaster combinations represented in the summary table;
Matches represented by the combined counts for the all of the match types in each row of each summary table which, for example for Agency Schedule vs. Detections matching would include all of the matches for all of the match types (such as ‘Ordered/Not Run’, ‘Partially Matched’, ‘Matched’ and ‘Unmatched Detections’) for one agency/advertiser/brand-product/market/broadcaster combination represented in the summary table; and
All matches represented in the entire summary table which, for example for Agency Schedule vs. Detections matching for example would include all of the matches for all of the match types (such as ‘Ordered/Not Run’, ‘Partially Matched’, ‘Matched’ and ‘Unmatched Detections’) for all agency/advertiser/brand-product/market/broadcaster combinations represented in the summary table.

Based upon the selection made in the respective summary panel, detailed, line-by-line comparative match results for each of the four Data Matching match types display, as follows:
Agency Schedule vs. Detections matching: Detailed data from each line of the agency schedule (agency, advertiser, brand/product, estimate number, market, broadcaster, broadcast week, day(s) of the week, air start/end times; program, spot length, and spot code) compared to detection data (date, day, time, program, spot length, and spot code);
Broadcaster Invoices vs. Detections matching: Detailed data from each line of the broadcaster invoice (agency, advertiser, brand/product, invoice number, market, broadcaster, date, time, spot length, and spot code) compared to detection data (date, day, time, spot length, and spot code);
Commercial Clearance: Detailed data from each line of the Agency Schedule (agency, advertiser, brand/product, estimate number, network, broadcaster, program, date, day, spot length, and spot code), supplemented and expanded by data from the broadcaster's station lineup (the number of times and the date(s) and time(s) each affiliate station is to air the commercial in each market, as well as the percentage of the U.S. population each market represents) for each program (including the expected numbers of detections, which represents the cumulative number of times each monitored affiliate is supposed to air the commercial, as per the lineup), compared to detection data (date, day, time, program, spot length, and spot code) from each monitored affiliates;
Program Clearance: Detailed data from each line of the broadcaster's station lineup data (the number of times and the date(s) and time(s) each affiliate station is to air each program in each market, as well as the percentage of the U.S. population each market represents) for each program, compared to detection data (date, day, time, program, program length, and program code) from each monitored affiliate.

In order to provide users with as much onscreen data display flexibility as possible, the majority of the column headers in the majority of the summary and detail data panels may be active links that sort and reverse the sorts of the data in the respective panel by that column's value. Additionally, onscreen Default Sort buttons may easily return any customer sorted data to its original default sort order onscreen.

In order to provide users as much data analysis flexibility as possible, the Online system may also provide permissioned agency and broadcaster users onscreen buttons with which to export Data Matching results data from the summary and detail panels for each of the matching analysis types (Agency Schedule vs. Detections, Broadcaster Invoices vs. Detections, Commercial Clearance, and Program Clearance) out of the Online system in Excel, XML and other possible formats, for additional analysis outside of the system and/or in their own internal systems.

The Online system may also allow users to easily modify and refresh Data Matching results data in the summary panels onscreen for each of the matching analysis types (Agency Schedule vs. Detections, Broadcaster Invoices vs. Detections, Commercial Clearance, and Program Clearance) by modifying any of the permissioned media type, matching analysis and/or data filter selections. The system may also allow users to easily modify and refresh Data Matching results data in the summary panels onscreen for each of the matching analysis types by modifying links/counts selected in the summary table.

The Online system may provide users relevant onscreen assistance and feedback for each feature in the form of a prompt text bar at the top of each screen.

Example Embodiments of Online Change Orders Functionality

As described earlier, there is significant fluidity to the specific terms of each Broadcaster Deal/Contract and Agency Schedule throughout the lifecycle of each agreement and its eventual fulfillment and billing. Evolving business objectives and advertising needs on the part of the advertiser, as well as constantly changing supply-and-demand pressures on each broadcaster's finite inventory of advertising airtime, (which can be subject to preemption by either the broadcaster's revenue objectives and/or forces beyond their control, such as weather, natural disaster breaking news, and technical breakdowns) are the main contributors to this fluidity.

Change Orders have typically been generated offline by both agencies and broadcasters to modify any of the details of the purchase contained in the Agency Schedule and/or a Broadcaster's Deal/Contract before, during or after an advertising campaign has aired. However, these ongoing changes must be reflected and reconciled in both the agency's media management system and the broadcaster's billing system in order for Broadcaster Invoices to ultimately match up to Agency Schedules before the agency will agree to pay the broadcaster. However, these modifications to the original data are typically made without the assistance or structure of any automated systems, and without any standardized file or data formatting,

The Online Change Orders capabilities provided by example embodiments of the present invention may allow permissioned broadcaster users to generate online Change Orders onscreen, based on individual units added to and/or removed from the Broadcaster Deal/Contract data (which are also verified by Detection data by a Broadcaster Deal/Contract to Detections match) as identified by system comparisons of iterative versions of the Broadcaster Deal/Contract data imported into the system; and to also submit them online to specific permissioned agency customers for approval or rejection.

Once the broadcaster and the agency verbally agree to a change to one or more units on an existing Broadcaster Deal/Contract, the Online Change Orders module may allow that broadcaster user to make a change to the original Broadcaster Deal/Contract file in their internal inventory/sales management system, and then upload that new, modified version of the deal/contract data into the Online system. The Online system may in turn compare the iterative versions of the file, (a Broadcaster Deal/Contract to Broadcaster Deal/Contract match), recognizing the new file as being a revised version of an existing file, and shall display data for the units removed from, added to and/or changed within the file onscreen. The system also recognizes and pre-associates added and removed units with the same serial numbers assigned by the broadcaster's system. The broadcaster user can then utilize onscreen tools to generate Change Order data onscreen for each of the pre-associated removed and added units with common serial numbers, as well as the unassociated removed and added units with unique serial numbers, and submit them to specific agency users for approval or rejection.

In addition to comparing iterative versions of Broadcaster Deal/Contract files for changes, the Online system may also compare each scheduled unit in the file against detection data to verify past airings to make sure a Change Order doesn't include any scheduled airings that did not actually air.

The Online Change Orders module may provide the following functionality options to the following users:
Create/Edit: Onscreen tools for users on broadcaster accounts to create and/or edit online Change Orders based on displayed changes to individual units resulting from system comparisons of iterative versions of Broadcaster Deal/Contract files uploaded to the system;
Approve/Reject: Onscreen tools for users on agency accounts to review and either approve or reject change orders submitted to them by a broadcaster user;
View: Onscreen tools for users on agency and broadcaster accounts to view status histories of Change Orders submitted by broadcaster users to specific agency users, including submission dates, as well as approval/rejection dates;
Audit Report: Onscreen tools for users on agency and broadcaster accounts to query, display and export listings of online Change Orders approved by agency users since a user-selected date, as an easy tool for users to then subsequently update changed schedule data in their internal systems.

The Online Change Orders module may also include a component that generates daily auto-emails notifying broadcaster users of:
Any incomplete change orders requiring onscreen user intervention in order to complete them; and
Any complete change orders requiring submission to an agency buyer for review, approval or rejection.

Similar to other modules, the Online Change Orders module may provide broadcaster users onscreen tools to query, filter and display specific Broadcaster Deal/Contract data in order to create or edit Change Orders by various values, including but not limited to:
Agency
Advertiser
Brand/product
Market
Broadcaster
Deal number
Contract number
Serial number (A broadcaster-assigned ID number for each advertising unit in the Deal/Contractfile) Date range.

In addition to displaying all of the changed units identified by the comparisons of iterative versions of a Broadcaster Deal/Contract file, the Online Change Orders module also allows national cable broadcaster users to display units that did not change, (along with those that did), as an additional onscreen reference tool when creating or editing online Change Orders.

As with other modules, the Online Change Orders module may also provide broadcaster users the onscreen ability to name, save, modify and/or delete frequently used sets of change order data filters for single-click selection of future Change Orders data; And also allows users to clear/re-set all change order filter selections to the system default options with a single button click.

Selecting Change Order data to display for a specific Broadcaster Deal/Contract file may display one or more of the following data onscreen resulting from the comparisons of iterative versions of deal/contract files:
Change Orders: A table displaying pairs or sets of changed units that the broadcaster pre-associated in their internal system with the same serial number for both units, typically either a unit that was removed from the original file and replaced by either a specific, completely different unit in the new file; or a unit in the original file that was modified in the new file. Pre-associated with a common serial number in the system, displays these changed units onscreen as being ready to be submitted to a specific, broadcaster user-selected agency user for review, approval or rejection.
Removed Units: A table displaying individual units that were in the original file, but that have been removed by the broadcaster in their internal system, and that are not in the new file, and for which there are no other units in the new file with a matching serial number The Online Change Orders module provides broadcaster users onscreen tools with which to categorize these unassociated removed units as either Credits (with associated costs to be credited to the agency) or Pre-Empts (which then require onscreen intervention to be associated with an Added Unit in the new file in order to be submitted to a specific, broadcaster user-selected agency user for review, approval or rejection).
Added Units: A table displaying individual units that were not in the original file, but that have been added by the broadcaster in their internal system, and that are contained in the new file, and for which there are no other units in the original file with a matching serial number The Online Change Orders module provides broadcaster users onscreen tools with which to categorize these unassociated added units as either Bonus (added at no additional cost to the agency at broadcaster's discretion; typically unsold inventory), Audience Deficiency Units (added at no additional cost to the agency at broadcaster's discretion; typically to offset under-delivery of other units on the schedule in terms of the projected audience size); Extra (added at additional cost to the agency at agency's request to increase the level of advertising weight); or Makegoods (which then require onscreen intervention to be associated with a Removed Unit from the original file in order to be submitted to a specific, broadcaster user-selected agency user for review, approval or rejection).
Unchanged Units: (if display option is selected): A table displaying individual units unchanged in both the original and the new, modified versions of the file as an additional onscreen reference tool for broadcaster users when creating or editing Online Change Orders.

The Online Change Orders module may allow permissioned broadcaster users to sort removed units, added units and unchanged units data based on various values by clicking on various column headers in each table; and to easily return any sorted data to its original, default sort order with a single click of a button.

The Online Change Orders module may also provide permissioned broadcaster users onscreen tools for associating one or more user-specified ‘Makegood’ unit from the Added Units panel with one or more user-specified ‘Pre-empted’ unit from the Removed Units panel into one single Change Order for submission by the broadcaster user to a specific agency user for review and either approval or rejection.

In addition, the Online Change Orders module may provide permissioned broadcaster users onscreen checkboxes for selecting one or more created or edited Change Order to specific permissioned agency buyers for review and either approval or rejection.

The Online Change Orders module may additionally provide permissioned broadcaster users an onscreen drop down selection box of all permissioned agency users for each deal/contract unit from which to select one or more permissioned agency user as the recipient of each created or edited Change Order for review and either approval or rejection.

The Online Change Orders module may also include a component that generates daily auto-emails notifying agency users of new change orders that have been submitted to them by a broadcaster user, and that are pending their approval or rejection.

The Online Change Orders module may also provide permissioned agency users onscreen radio buttons for approving or rejecting each completed Change Order submitted to them by any permissioned broadcaster users.

The Online Change Orders module may also include a component that generates daily auto-emails notifying broadcaster users of Change Orders that have been approved or rejected by permissioned agency users.

Further, the Online Change Orders module may also automatically return each component of any Change Orders rejected by permissioned agency users to the Removed Units or Added Units panels they originally displayed in so that the broadcaster who submitted them can modify and resubmit them to the permissioned agency buyer until they can be approved.

The Online Change Orders module may also provide onscreen tools for exporting data for approved Change Orders to the agency user's media management system as an update to the Agency Schedule in order to get the Agency Schedule data in the agency's media management system back in synch with the Deal/Contract data in the broadcaster's system.

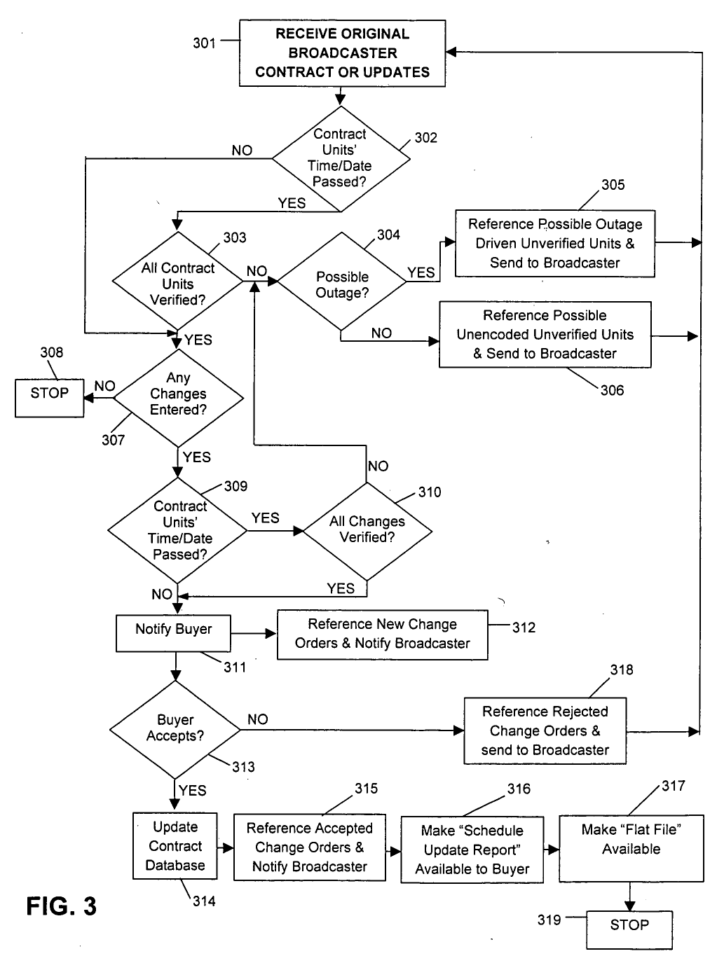

The Online Change Orders module may additionally provide broadcaster users with alternative manual method for entering changes to an original Deal/Contract file into the system, and creating and submitting change orders to an agency user for review and either approval or rejection (e.g. See FIG. 3).

The Online Change Orders module may also provide permissioned agency and broadcaster users an onscreen filter panel with which to query and display histories of the statuses of submitted change orders onscreen by various values, including but not limited to:
Agency
Advertiser
Brand/product
Market
Broadcaster
Deal#
Contract #
Serial #
Current Status:
   Approved
   Pending (awaiting approval or rejection) or
   Rejected
Date range.

As with other modules, the Online Change Orders module may also provide broadcaster users the onscreen ability to name, save, modify and/or delete frequently used sets of change order data filters for single-click selection of future Change Orders status data; And also provides users an onscreen tool to clear/re-set all change orders filter selections to the system default options with a single button click.

As with other modules, the Online Change Orders module may also provide permissioned agency and broadcaster users with onscreen tools with which to export submitted Change Order status history data to Excel, XML and other possible formats for additional analysis outside of the system.

As with all modules, and on all screens, the system may provide users relevant onscreen assistance and feedback for each feature in the form of a prompt text bar at the top of each screen.

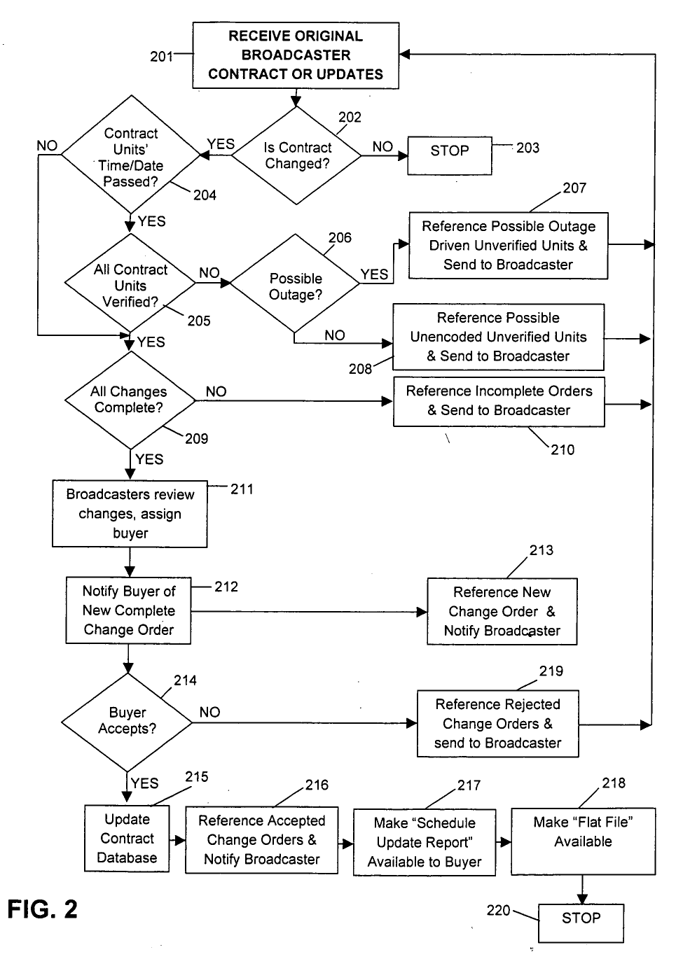

FIGS. 2 and 3 represent two exemplary methods in accordance with the present invention by which the Online Change Orders module is able to allow permissioned broadcaster users to generate online Change Orders onscreen, based on individual units added to and/or removed from the Broadcaster Deal/Contract data (which are also verified by Detection data); and to also submit them online to specific permissioned agency customers for approval or rejection:

Electronically Ingested Change Orders: As shown in the example embodiment of FIG. 2, the electronic ingestion method relies on automated comparison within the Online system of iterative versions of Broadcaster Deal/Contract data, which identifies and displays changed contract units for permissioned broadcaster users use in creating or editing Change Orders for submission to permissioned agency users for review and either approval or rejection. The flow chart of FIG. 2 starts with receiving original or updated versions of the broadcast contract/deal that are ingested by the Online system of the present invention (201). The received files may contain both past and future contract units that are slated to be aired at particular times and dates. Updated files may be received and ingested regularly to assess and identify any changes to the current scheduled events. These updates may include removed, added, or changed units relative to the previous version of the contact file. Upon receipt of any files, the contract is assessed to determine if any changes have taken place (202). If no changes are present (or if the contract is an original contract), no further action is required (203). In the presence of changes, the contract units' date and time is checked to determine if they units' time/date has already occurred (204). If the units have already aired (or should have been aired), it is next determined if all contract units are verified and accounted for (205). If units are not satisfactorily verified, it is next determined if the verification failure was due to possible outages of the monitoring network (206), and if so, possible outage and/or unencoded, ISCI-driven, and unverified units are identified (i.e., referenced) and sent to the Broadcaster (207). Broadcaster notification may be done, for example, using daily emails. In the absence of possible outages, the possible unencoded, ISCI-driven, unverified units are referenced and send to the Broadcaster (208). The Broadcaster may research possible outage-driven and/or unencoded ISCI-driven unverifiable units, and upload new version of the contract with changes to credit or makegood any missed units. Or, the Broadcaster may submit the unverified units to the Buyer.

If the Contract Units' time/date has not passed or if all contract units are verified, it is next checked to determine if all changes are complete (209). If all changes are not complete, incomplete Change Orders are referenced and sent to the Broadcaster (e.g., via daily emails) (210). The Broadcaster may complete the Change Orders by either categorizing and/or associating incomplete Change Orders manually on screen and submitting them to the Buyer, and/or re-importing new deal/contract file to the Online system with completed Change Orders. If all changes are complete, next, the Broadcaster reviews all changes and assigns the buyer (211). Next the Buyer is notified of the new and complete Change Order (212); Broadcaster is also notified regarding the submission of the new Change Order to the Buyer (213).

The Buyer then has the option of accepting or rejecting the change order (214). If the Buyer accepts the changes to the Change Order, the contract in the data base is updated (215), accepted Change Orders are referenced and sent to the Broadcaster (216), a schedule update report is made available to the Buyer (217), and a Flat File may be generated (218). A Flat File comprises a revised version of the contract/deal file that is compatible with, and can be automatically ingested by the Agency's internal media management file system. A buyer is then enabled to access these files within the Agency's media management system. If the Buyer rejects the changes, however, the Online system references the rejected Change Orders and notifies the Broadcaster (219). The Broadcaster may revise the rejected Change Orders by a combination of either re-categorizing and/or re-associating Change Orders manually on screen and re-submitting them to the Buyer, and/or by re-importing new deal/contract file to the Online system with revised Change Orders. Once the flat file is generated, the change order process is completed (220).
Manually Entered Change Orders: As shown in the example embodiment of FIG. 3, the manual entry method relies on electronic upload of an original Broadcaster Deal/Contract file only, with subsequent manual entry of any changes to any contract units in the file by permissioned broadcaster users in order to create or edit Change Orders for submission to permissioned agency users for review and either approval or rejection. The flow chart of FIG. 3 starts with receiving original or updated versions of the broadcast contract/deal that are ingested by the Online system of the present invention (301). The received files may contain both past and future contract units that are slated to be aired at particular times and dates. Updated files may be manually modified on screen to incorporate changes to the current scheduled events. These changes may include removed, added, or changed units relative to the previous version of the contract file. Upon receipt of any files, the contract is assessed to determine if the updated contract units' date and time has already occurred (302). If the units have already aired (or should have been aired), it is next determined if all contract units are verified and accounted for (303). If units are not satisfactorily verified, it is next determined if the verification failure was due to possible outages of the monitoring network (304), and if so, possible outage and/or unencoded, ISCI-driven, and unverified units are identified (i.e., referenced) and sent to the Broadcaster (305). Broadcaster notification may be done, for example, using daily emails. In the absence of possible outages, the possible unencoded, ISCI-driven, unverified units are referenced and send to the Broadcaster (306). The Broadcaster may research possible outage-driven and/or unencoded ISCI-driven unverifiable units, and upload new version of the contract with changes to credit or makegood any missed units. Or, the Broadcaster may submit the unverified units to the Buyer.

If the Contract Units' time/date has not passed or if all contract units are verified, it is next checked to any changes were entered (307). If no changes are entered (or if the contract is an original contract), no further action is required (308). In the presence of changes, it is checked to determine if contract units' time/date has passed (309). If it has, then it is determined if all changes have been fully verified (310). If changes are not fully verified, then it is checked to see if the culprit is possible monitoring system outages (304) as described above.

If the contract units' time/date is not passed or if the changes are all verified, the buyer is notified regarding the new Change Orders (311), and the Broadcaster is notified regarding the referenced Change Orders that were submitted to the Buyer (312). These notifications, as described above in connection with FIG. 2, may be conducted using email.

Next it is checked to determine if the Buyer has accepted the changes (313). If the Buyer accepts the changes to the Change Order, the contract in the data base is updated (314), accepted Change Orders are referenced and sent to the Broadcaster (315), a schedule update report is made available to the Buyer (316), and a Flat File may be generated (317). If the Buyer rejects the changes, however, the Online system references the rejected Change Orders and notifies the Broadcaster (318). The Broadcaster may remove the rejected Change Orders, or revise them by re-categorizing and/or re-associating Change Orders manually on screen and re-submitting them to the Buyer. Once the flat file is generated, the change order process is completed (319).

Example Embodiment of Online Traffic Functionality

The process of coordinating which versions of which commercials air how many times in which slots and at which times on which dates on which broadcasters in which markets on an Agency Schedule or a Broadcaster Deal/Contract is a separate process from the one of negotiating those particular terms of the Agency Schedule and/or Broadcaster Deal/Contract. This process is called traffic, and is conducted between staff in the agency's traffic department, who issue detailed Agency Traffic Instructions to staff in the broadcaster's traffic department. Using various forms of industry standard and/or proprietary spot identification codes, the Agency Traffic Instructions inform the broadcasters which versions of which commercials can be used to fulfill each of the airtime units on an Agency Schedule and/or a Broadcaster Deal/Contract.

An example embodiment of an Online Traffic module in accordance with the present invention may be designed to allow, inter alia:
Agency users to upload Agency Traffic Instructions files into the Online system;
Agency and broadcaster users to receive auto-email notification of new Agency Traffic Instructions uploads;
Permissioned agency and broadcaster users to set alert parameters for various media type/brand-product combinations that will generate alerts whenever Agency Traffic Instructions for that combination are uploaded, and Detection data for any broadcaster on those instructions indicate spots not airing as per the instructions (by an Agency Traffic Instructions to Detections match);
Agency and broadcaster users to receive auto-email notification of new Online Traffic Alerts;
Agency and broadcaster users to query, display and export onscreen summary and detailed Online Traffic Alerts data;
Permissioned agency and broadcaster users to clear Online Traffic Alerts;
Agency users to aggregate and forward specific Online Traffic Alerts data to specific users on broadcaster accounts to resolve the associated issues; and
Agency and broadcaster user to opt-in or opt-out of the auto-email notifications of new Agency Traffic Instructions uploads and/or new Online Traffic Alerts.

As described earlier in the Import section of this document, the Online system allows any users on an agency account to import Agency Traffic Instructions files. These files may be imported into the system in standard .xml format. The system also has the flexibility, with additional development, to extend this importation capability to Agency Traffic Instructions files in other formats.

The Online system may also allow designated users on both agency and broadcaster accounts to receive auto-email notification of new Agency Traffic Instructions file uploads as notification to agency users to make sure that Online Traffic Alerts are set for those instructions and/or to be aware of new instructions in the system that may begin generating Online Traffic Alerts.

The Online system may also allow users on both agency and broadcaster accounts to query and display Agency Traffic Instructions data that has been uploaded into the system, using onscreen querying and filtering tools similar to those described earlier in other Online modules. Drop down selection box fields upon which users can query and filter Agency Traffic Instructions data onscreen may include:
Media Type
Agency
Advertiser
Brand/Product
Estimate number
Market
Broadcaster
Spot Length and
Spot ID Code.

The Online system may also provide a pop-up broadcaster calendar for users to select a specific airdate for which they would like the system to return filtered Agency Traffic Instructions data that was, is or will be in effect on that date.

As with filter panels in other modules, the Online Traffic module may also provide permissioned users the onscreen ability to name, save, modify and/or delete frequently used sets of Agency Traffic Instructions data filters for future single-click selection, and to clear/re-set all traffic instructions filter selections back to the system default options with a single click.

As with data panels in other modules, the Online Traffic module may also allow permissioned users to sort Agency Traffic Instructions data based on various values, and to easily returning any sorted traffic instructions data back to its original, default sort order with a single button click.

The Online system may also provide users on both agency and broadcaster accounts that have been assigned View/set/clear traffic privileges by a customer administrator, (as described in the Data Security section of this document), onscreen tools with which to set specific alert parameters and settings for each of the types of traffic alerts supported by the system, including but not limited to:
Incorrect Rotations: Spots airing on broadcasters in percentages of the total number of spots for that brand/product airing on that broadcaster other than the percentages indicated on the Agency Traffic Instructions for each spot. For example, if an Agency Schedule indicates that a broadcaster is to air 10 spots for a particular brand/product, and the Agency Traffic Instructions for that brand/product on that broadcaster indicate that two spot codes (spot code ABCD-111 and spot code ABCD-2222) are to rotate at 50% each, then the broadcaster is supposed to air each of those spot codes five times in order to properly fulfill the Agency Schedule and Traffic Instructions. Airing either spot code at a percentage other than 50% results in an Incorrect Rotation alert.
Missed Upload Dates: In order for the Monitoring Network to be able to detect airings of specific commercials, broadcasters must air versions of those commercials that have been properly embedded with a unique watermark identifying each spot. If information regarding that embedding is not uploaded to the system by the user-defined number of days prior to the first scheduled airdate, a Missed Upload Date alert is generated.
Missed Start Dates: If no detections for a spot code are received by a user-defined number of days after to the first scheduled airdate, a Missed Start Date alert is generated.
Out-of-Flight Airings: If detections are received prior to the first scheduled airdate or after the last scheduled airdate, an Out-of-Flight alert is generated.
Airings during Blackout Periods: If detections of a spot code are received during a user-defined period of time during which spots are not supposed to air (for example between midnight and 6AM each night), a Blackout Periods alert is generated.
Airings on Incorrect Broadcasters: If detections of a spot code are received from broadcasters not included on the Agency Traffic Instructions for that spot code, an Incorrect Broadcaster alert is generated.

The Online system also allows permissioned agency and broadcaster users assigned View-only traffic privileges by a customer administrator to view existing alert settings for each advertiser/brand-product/media type combination, for each alert type onscreen, that have been previously established by other users with View/set/clear.

The Online system may also allow permissioned agency and broadcaster users with View/set/clear traffic privileges with onscreen capabilities to modify existing alert settings and/or set new alert settings for each advertiser/brand-product/media type combination, for each alert type described above.

As described earlier, the Online system may generate Traffic Alerts whenever:
Agency Traffic Instructions for specific spot codes for a particular brand/product to air on various monitored broadcasters have been uploaded into the Online system; and
An agency and/or broadcaster user with View/set/clear traffic privileges has activated alert parameter settings for that brand/product on those broadcasters' media type; and
Detections of airings of spot codes for that brand/product are received from monitored broadcasters in patterns other than those indicated by the Agency Traffic Instructions and the user-defined alert parameter settings.

The Online system may generate auto-email notifications to designated agency and broadcaster users recapping newly generated traffic alerts on a daily basis.

The Online system may also allow users on both agency and broadcaster accounts to query and display Online Traffic Alert data, using onscreen querying and filtering tools similar to those described earlier in other Online modules. Drop down selection box fields upon which users can query and filter Online Traffic Alert data onscreen may include:
Media Type
Agency
Advertiser
Brand/Product
Estimate#
Market
Broadcaster
Spot Length and
Spot ID Code.

The Online system may also provide a pop-up broadcaster calendar for users to select a specific date range for which they'd like the system to return filtered Online Traffic Alert data that was generated during that date range.

As with filter panels in other modules, the Online Traffic module may also provides permissioned users the onscreen ability to name, save, modify and/or delete frequently used sets of \Online Traffic Alert data filters for future single-click selection, and to clear/re-set all alert data filter selections back to the system default options with a single click.

As with data panels in other modules, the Online Traffic module may also allow permissioned users to sort Online Traffic Alert data based on various values, and to easily returning any sorted traffic alert data back to its original, default sort order with a single button click.

Similar to other Online modules, selecting and submitting specific Online Traffic Alert data filter parameters may first display a summary panel displaying summary counts of the numbers of each type of alert that have been generated for each media type/market/agency/advertiser/brand-product combination, including but not limited to:
Incorrect Rotations
Missed Upload Dates
Missed Start Dates
Out-of-Flight airings
Airings during Black Out periods
Airings on Incorrect Broadcasters.

The Online system may also allow permissioned users with onscreen tools with which to view lists of unmonitored broadcasters included in the filtered query results of Online Traffic Alert data, in order to avoid having users assume that all spots are airing correctly on a particular broadcaster since no alerts have been generated for that broadcaster, when in fact the broadcaster is not even being monitored.

The Online system may also allow permissioned agency and broadcaster users that have been assigned View/set/clear traffic privileges with onscreen tools with which to clear data for specific Online Traffic Alerts onscreen and from auto-email notifications of new alerts.

The Online system may also allow permissioned agency and broadcaster users with onscreen tools with which to display data for previously cleared traffic alerts based on the same filter query that returned the original Online Traffic Alerts results.

Similar to other modules, the Online Traffic module may also provide permissioned users with onscreen capabilities for drilling into and displaying detailed data for specific subsets of cleared and/or uncleared Online Traffic Alerts data onscreen by clicking on various counts/links in the initial summary panels.

The Online system may also provide permissioned agency users with onscreen tools with which to create emails for any agency-set alerts, and aggregate and forward them the specific corresponding broadcaster(s) in order to initiate dialogue with the broadcaster(s) regarding resolution of the issues causing the alerts.

As with summary and detail panels in other modules, the summary and detail panels in the Online Traffic module may provide permissioned agency and broadcaster users onscreen tools for sorting and reverse sorting Online Traffic Alert data by various values in the respective panel by clicking the column headers for the columns on which they would like the data sorted, as well as to return the sort of the data to the original default sort order with a single button click.

In addition to be able to display data regarding specifically generated alerts onscreen, the Online Traffic module may also provide permissioned agency users with onscreen capabilities to display Complete Rotation Data onscreen, that aggregates data for uncleared alerts, cleared alerts and correct rotations that did not trigger any alerts, across all broadcasters, into market-by-market recaps, which allows agency users to get a more complete view of how their commercials are airing on each station in each market, not just the ones that are generating specific alerts.

In order to allow individual users to control the number of system-generated auto-email notifications they receive, the Online Traffic module may also provide permissioned agency and broadcaster users onscreen tools for opting in or opting out of daily auto-email notifications of new Agency Traffic Instructions uploads and/or the generation of new Online Traffic Alerts. As with all modules, and on all screens, the Online system may also provide users with relevant onscreen assistance and feedback for each feature in the form of a prompt text bar at the top of each screen.

Example Embodiment of Data Management System

Raw ConfirMedia airplay detection data gathered at the individual monitoring sites in each media market by the Event Airplay Receivers (EARs) may be relayed to the Data Management System (DMS), and further processed into airplay detection events by the Airplay-to-Event Converter (AEC). Airplay detection events are then imported into the Online database for comparison to the various sets of customer imported data, including but not limited to schedules, deal/contracts, change orders, traffic instructions, and invoices.

Example embodiments of DMS are described in commonly owned, co-pending U.S. patent application No. 2004/0073916A1 SOL-171.

The prior art Data Management System (DMS) is supported by a Data Systems Infrastructure (DSI) consisting of computer hardware and software systems housed in the Control Center (CCC). The present invention provides a new set of capabilities that can be added to the existing DMS. The present invention may provide actionable discrepancy reports to customers by combining various forms of media data (including but not limited to broadcaster deals/contracts, deal/contract change orders, agency schedules, agency traffic instructions, network/syndicator affiliate lineups, and network/syndicator program clocks etc.) with detection data from the BMS, as well as a variety of supporting data (including but not limited to program data, station data, and audience measurement/ratings data). Once various data is imported, the system provided in accordance with the present invention may compare and match agency expectations, broadcaster declarations, and airplay events to produce discrepancy information. This information will be accessed and reported in a variety of ways.

Example Embodiment of an Online System

FIG. 4 illustrates the overall operation of an example embodiment of the present invention, which is also referred to herein as the “online system” or simply “the system”. Whenever the terms “Online System” or system” are used herein to describe certain aspects of the present invention, those terms should be understood as describing example embodiments only, and should not be understood as limiting the present to include or require those particular features. Those skilled in the art should appreciate that the present invention may be implemented to provide a wide variety of combinations of the many features and functions discussed herein.

In an example embodiment, prior to an advertising campaign (“pre-flight”), the broadcaster 34 offers advertising airtime to agencies 14. If an agreement to buy/sell is reached, the broadcaster enters the deal in their IT system as a contract. The contract is sent to the Agency 14 and entered as a “buy” schedule in their IT system. At any point in time after this during the campaign (“in-flight”) or after the campaign has completed (“post-flight”), the agency 14 may choose to upload this schedule to a schedule matching module 50 of the Online System. It will then be compared to what airplay detections 52 have occurred. Onscreen schedule matching may be provided to the agency 14 and viewed. Prior to the flight, the agency 14 may request that one of their production house support service providers 54 (e.g., DG Systems) embed the particular identifying watermarks into the commercials. The production house support service providers 54 also take key reporting metadata logs collected at the time of embedding and send that to schedule matching module 50. The agency 14 also establishes specific traffic instructions. These tell production houses 54, distribution services, and broadcasters 34 exactly which commercials to play to satisfy a particular buy. These traffic instructions are also entered into the Online System (e.g., system database 10 shown in FIG. 1). The spots are distributed and the broadcasters 14 air them. During this time (“in-flight”), the schedule matching module 50 executes matching logic with the traffic instructions, and provides alerts to the agency 14 and broadcaster 34 if any of the traffic instructions have not been followed. Also, if any changes are requested to the contract by either the agency 14 or broadcaster 34, these change orders are also entered into a change order management module 56 of the Online System. Online matching is performed to confirm these changes, and any associated, “make-goods,” bonuses, or credits. Once confirmed, agencies 14 may import the results of change orders into their IT system to update their schedule. After the campaign (“post-flight”), the broadcaster 34 generates an invoice for the campaign. This invoice is sent to an invoice matching module 58 of the Online System and matched against detections 52. The confirmed invoice is now considered payable and it is sent to the Agency 14. The updated schedule at the Agency 14 can also be rematched to perform a post-buy analysis of results delivered by the campaign.

It should be appreciated that, although FIG. 4 shows direct connections between: (a) agency 14 and broadcaster 34; and (b) schedule matching module 50, change order module 56, and/or invoice matching module 58, data used by schedule matching module 50, change order module 56, and invoice matching module 58 may be uploaded into, stored at, and obtained from the system database 10 (as described above in connection with FIG. 1). Alternatively, the schedule matching module 50, change order module 56, and/or invoice matching module 58 may include a corresponding database.

Those skilled in the art should also appreciate that schedule matching module 50, change order module 56, and/or invoice matching module 58 may form a single matching engine (e.g., matching engine 12 as shown in FIG. 1) or be arranged as discrete components as shown in FIG. 4. Further, the schedule matching module 50, change order module 56, and/or invoice matching module 58 (whether in the form of matching engine 12 or discrete components) may be co-located with system database 10 or located remotely from system database 10 or one or more corresponding databases which make up system database 10.

Example Embodiment of Online Matching

The core of the Online system is the system's ability to associate specific detected airplay events to a specific item or items contained in imported data files, including but not limited to agency schedules, broadcaster deals/contracts, network or syndicated broadcaster affiliate lineups and program clocks, agency or broadcaster change orders, agency traffic instructions, or various combinations of these items.

The general intent of the Online System matching logic is to perform matching in the background at times of data ingest in order to present the most current and accurate data possible. Detection events shall be automatically imported into the Online system each time the AEC (arrival to event converter) process runs (e.g., every 3 hours). The Online system, however, may allow matching whenever new data is ingested into the system that may change the existing matches that have been created. Current general guidelines may include: broadcaster invoices and contracts—once per week; agency schedules and traffic data—once per day; detection data—per the regular schedule (currently every 3 hours). Uploaded data may be validated by the system upon import for consistency and conformance to data within the system.

All newly imported detections that coincide with broadcaster, agency, advertiser, product, date/time range of data already in the system may be matched automatically. However, these detections may be released from any resulting matches and be available for re-matching at the time of additional customer data imports that also coincide with the broadcaster, agency, advertiser, product, date/time range of the detections.

The system and the matching logic may also be configured to handle:
Local time zones;
Local observance of ‘Standard’ time vs. ‘Daylight’ time;
Utilization of a ‘Standard Calendar’ format vs. ‘Broadcast Calendar’ format when defining ‘Day’, ‘Week’, ‘Month’ and ‘Year’;
Allowance for ‘Broadcast Calendar’ definitions of ‘Day’, ‘Week’, ‘Month’ and ‘Year’ to be configurable.
   Example Embodiment of Matching Hierarchy

The basic premise of the matching engine 12 (FIG. 1) is to compare data from two or more sources and find the most appropriate matches, relative to all of the possible matches, based on a complex series of matching requirements and priorities. The first stage of matching may include comparing basic eligibility of spots and detections. For example, one selection criteria to determine eligibility may include equivalency of the following metadata types: broadcaster, advertiser, and time. This eligibility establishes relationships between spots and detection events known as ‘edges’. The next stage is to assign a weighted score to the edges in accordance with the following criteria: ISCI or AdID present and equal, detection time within the natural or extended time range of the schedule, how large the schedule ISCI list is, how narrow the schedule time range is, and where in time the detection occurs in the schedule. Then a maximal weight maximal cardinality bipartite graph match is performed (this technique is generally described in prior art publications such as the one listed under the URL <http://www.algorithmic-solutions.info/leda_guide/graph_algorithms/bipartite_mwmc_matching.html>). The output is a single match of events to spots from among all possible assignments. Since matching is dictated by a weighting system, the third stage of matching is an annotation of these weighting effects called match notes. This is sometimes also referred to as a partial match: not all matching criteria have to match perfectly, but rather the best match within certain criteria is chosen.

Example Embodiment of Point-to-Point Matching Logic

Point-to-point matching logic may be used when a customer's data file contains specific times to be matched against a specific detection event time, (most likely for, but not limited to invoice matching for national cable, spot radio and spot television, since the activity reflected in broadcaster invoices shall already have aired, with the actual air dates and times represented in the invoice data). Point-to-point match type may allow a buffer of time before the exact event time, during which the comparison shall be classified as a match. This is called “pre-tolerance.” The point-to-point match type may allow a buffer of time after the exact event time, during which the comparison shall be classified as a match. This is called “post-tolerance.”

Example Point-to-Point Matching Algorithm:

Point-to-point matching for national cable, spot radio or spot television invoice matching is one of the simpler matching rule sets in the system. The following example algorithm which, for example, may be carried out by invoice matching module 58 illustrates the steps necessary to carry out the matching:

1. Assume a broadcaster's invoice data has already been imported into the system.

2. Select the eligible content record set based on the narrowest provided of: estimate, sales order or contract number, campaign, product, brand, advertiser, buyer, or agency.

3. Set the eligible airplay events to be those that aired on the broadcaster during the broadcast period covered by the invoice, and with content records found in the eligible content record set.

4. Set the time accuracy tolerance for the matching logic:
a. If the report order specifies a tolerance value, use that. Otherwise, use the value in the invoice disclaimer if present; otherwise, use the system default.

5. For each spot on the invoice, define its time window to be the interval beginning at the declared spot start time minus the time tolerance, and ending with the declared spot start time plus the time tolerance.
a. Note that because of this time window, spots may overlap.

6. For most spots that do not overlap with others, match events to spots as follows. Collect all events with start times in the time window of the spot. Then:
a. If any of the events have the same ISCI or AdID code as the spot, remove those events with different ISCI or AdID codes from the set eligible to match this spot.
b. From the remaining eligible events, match the event with the closest start time to the declared spot time.

7. If two or more spots do overlap, but none of the eligible events start in the overlapping region, consider each spot separately, and match as in step 5 above.

8. If two or more spots do overlap, and some of the eligible events start in the overlapping region, consider all spots contained within the windows of any of the overlapping spots eligible to match any of the spots in the overlapping set.
a. For each eligible event, compute the difference in its start time to each spot start time.
b. For each spot, create a candidate list of events that match its ISCI, sorted by ascending start time difference. Append to this the list of events that do not match its ISCI, but is again sorted by ascending start time difference.
c. Now consider each spot in ascending start time order; assign to it the event at the head of its candidate list.
d. Once an event is assigned to a spot through this matching process, it is no longer eligible for further matching.

Table 1 illustrates the different match types and the associated match notes and description for the spots that may be produced in accordance with the example point-to-point matching logic by invoice matching module 58.

TABLE 1
Example point-to-point invoice matching match types & notes

| MATCH | MATCH | |
|---|---|---|
| TYPE | NOTES | DESCRIPTION |
| Matched | (none) | All invoice line instances where there is a |
| | | perfect detection match on all criteria. |
| Matched | EXT | All invoice line instances where there is a |
| | TIME | perfect detection match on all criteria, but that |
| | | requires either the Pre- or the Post-TAT to |
| | | match on Time. |
| On | (none) | Invoice line instances w/no detection w/in |
| Invoices/Not | | time range +/−TAT. |
| Matched | | |
| On | OUT | Invoice line instances w/no detection w/in |
| Invoices/Not | | time range +/−TAT with an overlapping |
| Matched | | broadcaster or system outage. |
| On | UNENC | Invoice line instances that include Spot Codes |
| Invoices/Not | | w/no detection w/in time range +/−TAT, |
| Matched | | however metadata for the Spot Code on the |
| | | invoice line has not been received in the |
| | | systemdatabase. |
| Unmatched | (none) | Detections outside of the time range +/−TAT |
| Detections | | for any invoice line instances, or surplus |
| | | detections w/in an invoice line instances' time |
| | | range +/−TAT after all of the instances have |
| | | been successfully matched. |

### Example Embodiment Of Point-To-Range Matching Logic

Point-to-range matching may be used when a customer's data file does not contain specific times, and instead contains a range of times to be matched against detection events with specific times. The objective of point-to-range matching is then to find the ‘best’ match from multiple detection events that fall within the range of times allowed by the customer's data, and therefore can be matched to the customer's data. Point-to-range matching may also allow pre- and post-tolerance buffers, and is most relevant to agency schedule vs. detection data matching.

Example Embodiment of a Point-to-Range Matching Algorithm

This section describes an example embodiment of a point-to-range matching algorithm which may be carried out by the schedule matching module 50 in accordance with the present invention. In this description, the term “spot” is used to refer to a generic piece of customer data: an individual scheduled spot, a spot as described as part of a unit descriptor in a buy line, a unit on a network order, etc. The term “event” is used to describe an airplay event (i.e., a collection of related detections that are grouped together).

1. Assume customer data has already been imported into the system. A set of “eligible spots” is chosen using the DATA PARAMETERS options (filter block) of the Online interface. This spot selection is done via user input of the values such as Agency, Advertiser, Product Group, Brand/Product, Estimate number, Market, Broadcaster, Network, Program, Daypart, Spot Length, Spot Code (ISCI), Start and End Dates.
a. Select the eligible spots based on the narrowest provided of the DATA PARAMETERS filter block described above: estimate, sales order or contract number, campaign, product, brand, advertiser, buyer, or agency.

2. Select the “eligible airplay events” to be those that aired on the specified broadcaster during the time period covered by the Start and End Dates.

3. Set the time accuracy tolerance for the matching logic:
a. First use any user specific settings, if present;
b. If none are present, use account specific settings, if present;
c. If none are present, use media type settings, if present; or
d. Use the system default.

4. For each eligible spot, define its time window to be the interval beginning at the declared spot start time minus the time tolerance and ending with the declared spot start time plus the time tolerance.
a. Note that because of this time window, spots may overlap.

5. For each eligible spot, compute the absolute value of the difference between the declared spot start time and all eligible events.

6. Assign events to spots in a one-to-one manner. In most realistic cases, more than one combination of assignments of events to spots will be possible. Choose the one that maximizes the number of events assigned to spots. If more than one such match exists, then choose the assignment that maximizes the weighted score of the match (discussed in the next section).

7. Check and mark each spot/event pair:
a. Mark as “MATCHED” those spots with associated events whose start time is within the spot time window and that match their customer data.
   i. When comparing customer data, use the most narrow or specific first; e.g., check in order ISCI, then Spot Length, Daypart, Network, Estimate, Product, Brand, Advertiser, Agency.
   ii. If either spot or event has a missing customer data field, consider it a match.
   iii. If both spot and event have a particular Media Schedule Description (MSD) value (e.g., description of scheduled broadcast times, dates, etc.) specified, and some specific values match, but further up in the hierarchy there is a mismatch, flag this as a data inconsistency error. For example, if the content record stores the spot length as 30 seconds but the customer data states that it is a 60 second spot, this needs to be flagged, even though the rest of the match may be perfect.
b. Mark as “PARTIAL MATCH—INCORRECT SPOT” those spots with associated events whose start time is within the spot time window but do not match the ID codes.
c. Mark as “PARTIAL MATCH—INCORRECT LENGTH” those spots with associated events that do not have ID codes on the schedule, and with mismatched lengths.
d. Spots that have events assigned but have neither matching ID code nor a start time within the spot window will have their assignment association broken.
e. All remaining spots without events are checked against the monitored station list and system outage data. Mark as “SCHEDULED—NOT RUN” those spots that are unaffected by the monitored station list and system outage data. Those spots that could have been missed due to a system outage are marked “NOT VERIFIED.”
f. Mark all remaining events without spots as “RUN—NOT SCHEDULED.”

Table 2 below illustrates the different match types and the associated match notes and description for the spots that may be produced by the schedule matching module 50 in accordance with the example point-to-range matching logic embodiment discussed above.

TABLE 2
Point-to-range schedule matching match types & notes

| MATCH | MATCH | |
|---|---|---|
| TYPE | NOTES | DESCRIPTION |
| Matched | (none) | All buy line instances where there is a perfect |
| | | detection match on all criteria, (including Spot |
| | | Length), whether or not Spot Codes are included |
| | | on Schedule or Traffic Instructions have been |
| | | imported. |
| Matched | INC LEN | Where there is a buy line instance w/a detection |
| | | w/in time range +/−TAT, and there are Spot Codes |
| | | on the Schedule, and they match the detection, but |
| | | the Spot Lengths are different. |
| Matched | EXT TIME | All buy line instances where there is a perfect |
| | | detection match on all criteria, (including Spot |
| | | Length), whether or not Spot Codes are included |
| | | on Schedule or Traffic Instructions have been |
| | | imported, but that requires either the Pre- or the |
| | | Post-TAT to match on Time. |
| Partial Match | CODE | A buy line instance w/a detection w/in time range |
| | | +/−TAT where Spot Codes don't match. |
| Partial Match | LEN | A buy line instance w/a detection w/in time range |
| | | +/−TAT, but: a) the Spot Lengths are different, |
| | | and b) there are no Spot Codes on the Schedule or |
| | | Traffic Instructions imported. |
| Ordered-Not | (none) | Buy line instances w/no detection w/in time range |
| Run | | +/−TAT. |
| Ordered-Not | ROTAT | Buy line instances w/no detection w/in time range |
| Run | | +/−TAT where the buy line rotation dates are not yet |
| | | complete. |
| Ordered-Not | DETS | Buy line instances w/no detection w/in time range |
| Run | | +/−TAT where there are known delayed detection |
| | | events and/or the final AEC run for the buy line's |
| | | time period is not yet complete. |
| Ordered-Not | OUT | Buy line instances w/no detection w/in time range |
| Run | | +/−TAT with an overlapping broadcaster or |
| | | system outage. |
| Ordered-Not | UNENC | Buy line instances that include Spot Codes w/no |
| Run | | detection w/in time range +/−TAT, however |
| | | metadata for the Spot Code on the buy line has not |
| | | been received in the system database. |
| Unmatched | (none) | Detections outside of the time range +/−TAT for |
| Detections | | any buy line instances, or surplus detections w/in |
| | | a buy line instances' time range +/−TAT after all of the |
| | | instances have been successfully matched. |

Schedule Match Test Cases Illustrating Rule Interactions

The following provides an example of schedule matching performed by schedule matching module 50 in accordance with an example embodiment of the present invention:

Definitions:

ISCI. Industry Standard Coding Identification; the unique code identifying specific commercial spots

TAT: Time Accuracy Tolerance; the amount of time a buy interval is extended to account for time inaccuracies

Earliness: Absolute value of the difference of the detection start time and the buy start time; this has the effect of inverting the order of those in the extended start of the buy interval.

RNO: Run-Not-Ordered; a detection that matches no buy lines. This may occur, for example, when there are two purchases (‘buys’) of a commercial to be aired but there are three detected airings of that commercial. Thus one airing is labeled as an ‘RNO’.

ONR: Ordered-Not-Run; a buy line with no matching detections

Example Match Weighting Hierarchy

The following provides a set of five example rules for match determination. These rules are listed in the order of priority, from the most important to the least important.

1. Score more points if the detection ISCI is on the buy traffic instructions “Preferred ISCI list.” Two match preferences are provided: Strict Mode and non-strict mode. In strict mode if an ISCI list is provided on the buy, detection ISCIs must match. In non-strict mode ISCIs on the buy are given a preferred weight, but not mandatory.
a. If ISCIs are not provided on the traffic instructions, use spot durations instead.

2. Score more points if the detection is in the Buy's natural time interval rather than its TAT extended time.

3. If the detection qualifies for more than one buy interval, and the detection is on more than one buy preferred ISCI lists, match the detection to the buy with the smaller preferred list.

4. If the detection qualifies for more than one buy line interval, match the detection to the buy with the smaller time interval.

5. Prefer match detections that are earlier in the buy time interval, with first precedence to those within buyTimeNatural, then move to those that match due to extending the beginning to the end within the extended end, give precedence to those that arrived from the extended beginning.

### DESCRIPTION OF EXAMPLES 1 THROUGH 31

The Appendix illustrates several matching examples in accordance with rules 1 to 5 that are listed above. In the examples shown in the Appendix, buy time intervals are represented by dark rectangles that span a certain duration of time. These natural buy time intervals may also sometimes referenced as ‘unextended buy interval,’ or the short hand ‘unextended’. TAT intervals are represented by light rectangles that appear on both sides of the buy interval. The preferred ISCI list of codes (shown Appendix as “Preferred ISCI List: 1,2,3,” or “ISCI's: 1,2,” etc.), if present, is also shown inside the buy interval rectangle. Finally, the rectangles represent detections from the system; the corresponding ISCI codes or detection durations are also displayed on the same line as the detections. These examples illustrate how a detection may or may not satisfy rules 1 through 5. A check mark indicates the conformance of the detection to the criteria specified by the corresponding rule.

For instance in Example 1, the buy Preferred ISCI List comprises ISCI codes 1, 2, and 3. In this example, there are 2 detections, with ISCI codes 88 and 89, that appear within the buy time interval. Since codes 88 and 89 are not on the Preferred ISCI List, rule 1 is not satisfied. However, rule 2 is satisfied since both detections appear within the span of the buy interval. Rules 3 and 4 are not relevant since only one buy is present. Finally, according to rule 5, the detection with ISCI code 88 appears earlier during the buy interval and is thus preferred over the detection with ISCI code 89.

The operation of examples 2-31 included in the Appendix will be readily apparent to those skilled in the art.

Overview of Example Commercial Clearance Functionality & Matching

In an example embodiment of the present invention, commercial clearance may be available to engaged network and syndication broadcaster and agency users. Commercial clearance is the verification of individual commercials scheduled to air on network radio, network television and syndicated television, through a comparison of agency schedules (ingested by agency users) that have been supplemented with affiliate station ‘lineup’ lists (ingested by broadcaster users), for each program on the schedule, against detection data for each local market affiliate television or radio station. Commercial advertising time scheduled for the media types such as, National Cable, Spot Radio and Spot Television, is scheduled directly with the individual broadcaster, either on a daypart rotation or in specific program being aired by that broadcaster. Commercial advertising time for network radio, network television and syndicated television, however, is scheduled with a network or syndicating entity who in turn has agreements from a collection of local market stations in different markets across the country to air its program and commercial content.

The Online system commercial clearance functionality may allow agencies and broadcasters to monitor how affiliate stations air these commercials either within or in conjunction with the network or syndicated programming they are contracted to air.

Agencies may use specifically designed tools to embed their commercials uniquely by broadcast medium/media type and network/syndicator prior to distribution to each radio or television network, or television syndicator. Agencies may ingest network radio, network television and syndicated television schedules into the Online system just as they ingest national cable, spot radio and spot television schedules.

Network and syndicated broadcasters may ingest station lineups for each of their respective programs into the Online system on a regular basis as well, and maintain a current database of lineup information for each of their programs in the system database. 10 (FIG. 1) Station lineups may provide the market rank, market name, call sign, and dial position for each affiliated station contracted to air a particular network or syndicated program (as well as the commercials scheduled to air within it) during a particular period of time (e.g., on a broadcast week basis). They may also provide the specific date(s) and time(s) (e.g., in local time) that each affiliate is contracted to air the program in their respective market.

Network and syndication commercial schedules ingested by an agency may be supplemented by this additional station lineup data from engaged broadcasters for comparison against commercial detection data for all of their local market affiliate stations.

Overriding capabilities may also be provided as for example, the lineups ingested by the broadcaster comprising dates, times, and number of times a market is allowed to carry a show, may override those corresponding values from the schedules ingested by the agency. In addition, if an agency schedule includes program lineups from broadcasters that are not participating in the Online system, third party program lineup data may serve as substitute lineup data. This represents a ‘one-to-many’ relationship between schedule data and detection data. ‘One’ line item on a network or syndicated schedule may be verified by ‘many’ detections, each coming from an individual, monitored affiliate station in various local markets; with the detections then aggregated to verify—or ‘clear’—the original network or syndicated schedule line item.

At the network or syndicator level, the Online system may represent commercial clearance on an actual count basis, as well as on a ‘percentage-of-US-population’ basis. For instance, if a network commercial should have aired on 100 monitored affiliate stations, the system may provide the onscreen ability to drill down into detailed data to see the 98 monitored affiliates that aired the commercial correctly and the two that did not, if those were the results of the matching analysis. In addition, the system may also represent commercial clearance data based on the percentage of the country's population represented by the markets in which monitored affiliate stations did or did not correctly air the commercials, based on percentage population data from the Station Schedule data (e.g., BIA) and market population database. For instance, in the above example, the system also displays the percentages of the total US population representing those 98 stations that correctly aired the spot and the two that did not.

Example Commercial Clearance Matching

Commercial clearance matching may require detections from multiple local market affiliate stations for a particular network or syndicated program (as identified in the affiliate station lineup provided by the network or syndicator) for a unit on a network radio, network television or syndicated television schedule to be fulfilled (i.e., ‘cleared’). The following illustrates some of the key rule, features, and benefits which may be provided by the commercial clearance matching function in accordance with an example embodiment of the present invention.

Expanding Schedule Lines: Individual lines on agency network radio, network television and/or syndicated television schedules are ‘expanded’ to incorporate each local airing date/time on each local market affiliate station as defined in the station lineup provided by the broadcaster.

Date/Time Ranges: The schedule date/time ranges for detection collection and matching purposes are typically much narrower than they are for national cable, spot radio or spot television schedules, especially for network television and syndicated television. (Network radio date/time ranges are still likely to be broader.) Instead of multi-day rotations, network and syndicated schedules and station lineups will likely have a specific air day/date on each affiliate for each line item unit. In addition, instead of broad daypart, or even multi-daypart time ranges, network and syndicated schedules and station lineups may have a more defined time range based on the start and end times of the program in which the unit is scheduled to air on each local market affiliate station. The one exception to this may be in network radio where, in addition to selling program-specific advertising (e.g. The Rush Limbaugh Show) that must air within that particular program, on a particular date, radio networks also sell broader packages based on dayparts and formats where certain affiliates are required to air certain commercials a certain number of times over the course of a certain number of days or times, as defined in the station lineup. The key is associating multiple commercial detections from multiple local market stations to individual schedule line items.

Time Tolerances: Since network and syndication advertising is bought primarily to air in specific markets and reach the audiences of specific programming, the time tolerances allowed in Schedule and Invoice matching are not typically allowed for network and syndicated advertising. However, to incorporate maximum flexibility into the system, the online system allows the agency and broadcaster users to configure pre- and post-match time tolerances in different ways, for example by agency, by advertiser, or by media type.

Broadcast Calendars: The concept of broadcast day/week/month calendars is applied to program and clearance matching. Broadcast day start/end times are thus configurable in different ways, for example, by account, by agency, by advertiser, or by media type. For matching purposes, the system accommodates broadcast day and date conversions and appropriately matches detections to agency network and syndication schedules and station lineups based on the broadcast day parameter specified for the broadcaster or the agency respectively. A broadcast week starts at the beginning of the broadcast day (e.g., in local time) on Monday and ends at the end of the broadcast day on Sunday. A broadcast week is defined after adjusting the calendar day and date to conform to the customer's specification of broadcast day. For example, scheduled unit that airs at 6:01 am on Monday, Jun. 7, 2004 shall not be considered for matching against a detection occurring at 5:58 am on Sunday, Jun. 6, 2004 for a customer with 6:00 am to 5:59:59 am broadcast day parameter settings. In this example, a broadcast month ends on the last Sunday of the current month, and a new broadcast month begins on the Monday immediately following the last Sunday of a month. All Broadcast Months are exactly 4-weeks long or exactly 5-weeks long.

Matching Data: Commercial clearance utilizes a sequential, three-tiered matching process involving four types of data: 1) Station lineup; 2) Program clock; 3) Agency schedule; and 4) Detection data (including station monitoring and system outage data, as well as third party broadcaster, market population and program data). The first tier matches station lineup and program clock data. The second tier matches the results of the first tier matching with agency schedule data. An overlap analysis is also performed such that the narrower time interval of the program clock or agency schedule is used. The third tier matches the results of the second tier matching with ConfirMedia detection data.

Matching Frequency: Commercial clearance matching runs upon the ingest of any new station lineup, program clock and/or agency schedule data into the system. If no new data is ingested, commercial clearance matching runs automatically once each night.

Detection Matching: While many network or syndicated commercial detections may match to one schedule/lineup line, no individual commercial detection are matched to more than one schedule/lineup line.

Collection Process: The commercial clearance matching process may use the following example collection criteria to select eligible commercial detections that can be matched against a specific agency network or syndicated schedule, supplemented by broadcaster lineup data. It should be noted that the following list provides a set of example criteria for the collection process. As such, this list may be modified to replace or supplement some of the listed criteria.
Commercial detections where the media type matches the medium and media type on the agency schedule are selected for matching;
Commercial detections that fall within the start date/time and the end date/time of the agency network or syndicated schedule are selected for matching (including any configured time tolerance thresholds);
Commercial detections where the agency name matches (including aliases) the agency name on the schedule are selected for matching;
Commercial detections where the advertiser name matches (including aliases) the advertiser name on the schedule are selected for matching;
Commercial detections where the brand/product name matches (including aliases) the brand/product name on the schedule are selected for matching; and
Commercial detections where the call sign and band of the local market affiliate station (or stations if it is an A/F or sister station combo buy) is included on the broadcaster lineup in effect for the program on the agency schedule at the time of the detection are selected for matching.

All collection criteria above must be satisfied for a commercial detection to be eligible for matching against a specific network or syndicated television schedule. In addition, for a network radio commercial detection to be eligible for matching against a network radio agency schedule, the network name must be captured and associated to the content record, and match (including aliases) the network name on the agency schedule. Separate detection collection and matching may be performed for each network or syndicator that is listed in an agency schedule.

Matching Process: The collected detection events, that are eligible for matching against a specific agency network or syndicated schedule, are matched when the Start and End times of a detection event match to, and fall within, the date/time of a network/syndicated schedule line item unit. Spot code information is only taken into consideration for network or syndication matching when it is available on a network or syndication schedule, or included in traffic instructions associated with the schedule. When spot code information is included on a network or syndication schedule or traffic instructions, and the detection spot code does not match, this is still considered a ‘Partial Match’ clearance match (as described shortly), and flagged in the notes as an incorrect spot code. If multiple detections could be used equally to fulfill a match for an affiliated local market station on the agency schedule and station lineup, then the first encountered match is used. For commercial clearance matching purposes, all data must be reflective of its status and state at the time of the activity being analyzed, not its status or state at the time the query was run. An exemplary list of such data comprises:
Affiliate lineup date
Segment lineup data
Station lineup data
Monitored station data
Outage data
BIA broadcaster and market population data
TMS program data.

Unscheduled Airings: Unmatched network and syndicated detections remain eligible for future matching. However, they are more likely to be considered ‘Unscheduled Airings’ and not matched to any future schedules. Detections that correspond to unscheduled network or syndicated airings (during the broadcast period being queried and reported) are provided to broadcaster and agency users. Broadcaster users, in particular, may reference these detections for the purposes of affiliate management and updating their program lineup data in the online system.

Partial Matches: An example of partial commercial clearance matches includes, but is not limited to, instances where an agency network or syndicated schedule includes spot codes and subsequently a local market affiliate station airs a spot for the correct advertiser brand/product in the correct program, but airs either a different spot code and/or a spot with an incorrect commercial length.

Unmonitored Stations: Commercial clearance match data may only be displayed for stations that are covered by the ConfirMedia® Broadcast Monitoring System (“monitored stations”). Thus only monitored stations may be identified in either summary or detail tables as having cleared (‘Cleared’), not cleared (‘Not Cleared’), or partially cleared (‘Partially Cleared’) a particular network or syndicated commercial. In addition, only monitored stations are included in commercial clearance match results represented as a percentage of the country's population. While data results for unmonitored stations are not displayed in online screens, unmonitored stations may be included in the import confirmation email to, and displayed onscreen for the party ingesting a document, informing the user of new stations being added to the monitoring network. Additionally, each data set returned may accompany an onscreen link, allowing users easy access to a basic listing of unmonitored stations associated with that data set.

Match Types: The commercial clearance match types for individual local market affiliate stations may include, but is not limited to:
Cleared
Partially Cleared (incorrect spot code, or commercial length)
Not Cleared (including possible outage notations)
Unscheduled Airing.

As with invoice and schedule matching, match comments or notes may be utilized in program and commercial clearance matching to clarify particular match types, on both the network/syndication level and the local market affiliate station level. Issues clarified by such notes may include, but are not limited to:
Incorrect spot codes
Incorrect commercial length
Incorrect broadcast day
Below minimum clearance threshold
Incomplete broadcast day
Prior to airdate
Possible outage.

Both schedule vs. detections and commercial clearance data matching results may include additional broadcast advertising media stewardship data, including but not limited to:
Time separation analysis: Onscreen capabilities to display instances where specific spots for advertisers and brands/products air on individual broadcasters without the agreed upon separation in time; and
Audience delivery: Incorporation of television and radio audience delivery/ratings data into broadcast verification data for various match results, including but not limited to reschedule matching, invoice matching, commercial clearance.

Table 3 below illustrates an example of the different commercial clearance match types, and the associated match notes and description. While this table is generated based on the above-described rules, functionalities and features, it is well understood that the incorporation of additional features and functionalities may eliminate certain match types, introduce new match types, or both.

TABLE 3
Example Commercial Clearance matching match types & notes
COMMERCIAL CLEARANCE

| | Match | | |
|---|---|---|---|
| Media Types | Type | Notes | Definition |
| Syndicated | Cleared | | A commercial line item on a program schedule for a station |
| Television, Network | | | included on the current station line up for that program that |
| Television and pre- | | | lines up with a detection event from that station as follows: |
| recorded In- | | | Commercial spot codes match; |
| Program Network | | | Air dates match; |
| Radio | | | Start times match within +/−2 minutes. |
| | Partially | Diff. | A commercial line item on a program schedule for a station |
| | Cleared | Code | included on the station line up for that program that lines up |
| | | | with a detection event from that station as follows: |
| | | | Commercial spot codes do not match, but agency, |
| | | | advertiser & brand/product do; |
| | | | Air dates match; |
| | | | Start times match within +/−2 minutes. |
| | Partially | Diff. | A commercial line item on a program schedule for a station |
| | Cleared | Date | included on the station line up for that program that lines up |
| | | | with a detection event from that station as follows: |
| | | | Commercial spot codes match; |
| | | | Air dates do not match; |
| | | | Start times match within +/−5 minutes. |
| | Partially | Diff. | A commercial line item on a program schedule for a station |
| | Cleared | Time | included on the station line up for that program that lines up |
| | | | with a detection event from that station as follows: |
| | | | Commercial spot codes match; |
| | | | Air dates match; |
| | | | Start times do not match within +/−2 minutes. |
| | Not | | A commercial line item on a program schedule for a station |
| | Cleared | | included on the station line up for that program for which no |
| | | | corresponding detection event from that station for that |
| | | | commercial exists where at least two of the three match |
| | | | element values (commercial spot code, date, or start time +/−5 |
| | | | minutes) match. |
| | Not | Outage | A ‘Not Cleared’ match type that may have been caused by an |
| | Cleared | | outage. |
| | Not | Un- | A ‘Not Cleared’ match type that was caused by an un-encoded |
| | Cleared | encoded | content. |
| | | Content | |
| | Unscheduled | | Any commercial detection event from a station not included |
| | Airing | | on the station line up for any program in which that |
| | | | commercial is scheduled to air, OR any commercial detection |
| | | | event from a station included on the station line up for a |
| | | | program in which the commercial is scheduled to air, for |
| | | | which no unmatched commercial line item on a schedule on |
| | | | that station for that program exists where at least 2 of the 3 |
| | | | match element values (commercial spot code, date, or start |
| | | | time +/−2 minutes) match. |
| Network Radio Line | Cleared | | A commercial line item on a line network schedule for a |
| Networks | | | station included on the current station line up for that line |
| | | | network that lines up with a detection event from that station |
| | | | as follows: |
| | | | Commercial spot codes match; |
| | | | Air date/time range matches within +/−2 minutes. |
| | Not | | A commercial line item on a line network schedule for a |
| | Cleared | | station included on the current station line up for that line |
| | | | network for which no detection event from that station for |
| | | | that commercial spot code exists within +/−2 minutes of the |
| | | | date/time range during which that commercial spot code was |
| | | | scheduled to air on that station. |
| | Not | Outage | A ‘Not Cleared’ match type that may have been caused by an |
| | Cleared | | outage. |
| | Not | Un- | A ‘Not Cleared’ match type that was caused by an un-encoded |
| | Cleared | encoded | content. |
| | | Content | |
| | Unscheduled | | Any commercial detection event from a station not included |
| | Airing | | on station line ups for line networks on which commercials |
| | | | for that agency/advertiser/brand-product are scheduled to air, |
| | | | OR any commercial detection event from a station included |
| | | | on station line ups for line networks on which commercials |
| | | | for that agency/advertiser/brand-product are scheduled to air, |
| | | | for which no unmatched commercial line item on a line |
| | | | network schedule for that station for that spot code, and with |
| | | | a date/time range that overlaps (+/−2 minutes) the detection |
| | | | event exists. |

NOTE:
Unmonitored stations included in lineups displayed in separate table.

Overview of Example Program Clearance Functionality & Matching

In an example embodiment of the present invention, the Online system program clearance may be made available to only certain tiers of system customers. For example, while engaged network and syndication broadcasters may have access to program clearance information, agency users and non-engaged broadcasters may not have access to program clearance data. Network and syndicated broadcasters may use the Online system to manage their affiliates compliance with contracts in a similar fashion that agencies manage broadcasters. In this case, they may embed their programs uniquely prior to distribution to each affiliate station, just as agencies embed commercial content before distribution. Programs differ from commercials in many ways (e.g., duration, segmentation, scheduling, etc.), but the Online system of the present invention enables tracking and confirmation of program clearance simultaneously with commercial campaign reconciliation.

Station lineup data, for each program that is ingested into the online system by the network and syndicated broadcasters for commercial clearance described above, may also similarly compared to local market program detection data. This may be done to monitor how affiliate stations air each of the network's or syndicator's programs relative to their respective contractual obligations as defined in the ingested lineup data. Based on the comparison of the station lineup data for each program and the local program detection data, match types may include programs that either do not air; air on the wrong date or at the wrong time; do not air in their entirety; air on an unscheduled basis, or the like. Additionally, broadcasters have the option of embedding unique watermarks into each program segment and/or commercial pod within a program, and then ingesting segment- or pod-specific station lineup data for a given program. While this feature may be useful to all users of the Online system, it may be most beneficial to network radio and syndicated television users. A common example of this program segmentation is a three-hour network radio program, such as the Rush Limbaugh Show, that is broken into three separate one-hour segments, where each segment may further be broken down into three or four 10- or 11-minute program segments, and three or four two-minute network commercial pods (with the balance of the time allocated to the local station for local programming and commercial airtime). Each program segment and each network commercial pod within each hour may be uniquely watermarked by the network for more robust program monitoring and clearance analysis, including identifying instances where affiliate stations aired segments out of order.

Program clearance matching may also require one detection from every local market affiliate station in order to clear a particular network or syndicated program schedule lineup. The following illustrates some of the exemplary rules, features, and benefits of program clearance matching.

Affiliate Station Lineups: Network radio, network television and/or syndicated television lineups provide specific air date/time information for each program on each affiliate station.

Program Segment Lineups: Network radio and/or syndicated television segment lineups provide specific lengths and codes for each segment and/or commercial pod within a program on each affiliate station.

Time Tolerances: To incorporate maximum flexibility into the system, pre- and post-program clearance match time tolerances are configurable by broadcaster at the account level.

Broadcast Calendars: The same broadcast calendar vs. standard calendar functionality as defined in relation to commercial clearance matching applies to program clearance matching functionality.

Matching Frequency: Program clearance matching may run with the same frequency as defined in relation to commercial clearance matching.

Detection Matching. No program detection may be matched to more than one network or syndicated program schedule/lineup line.

Collection Process: The program clearance matching process may use the following collection criteria to select eligible program detections out of the database that can be matched against a specific network or syndicated program lineup:
Program segment and/or commercial pod detections where the media type matches the medium and media type on the program lineup are selected for matching;
Program segment and/or commercial pod detections that fall within the start date/time and the end date/time of the network or syndicated program lineup are selected for matching (including any configured time tolerance thresholds);
Program segment and/or commercial pod detections where the derived network name matches (including translation tables) the network name on the program lineup are selected for matching;
Program segment and/or commercial pod detections where the program name matches (including translation tables) the program name on the program lineup are selected for matching; and
Program segment and/or commercial pod detections where the name of the local market affiliate station (e.g., call sign plus band) is included on the lineup in effect for the program at the time of the detection are selected for matching.

All collection criteria above must be satisfied for a program detection to be eligible for matching against a specific network or syndicated television program lineup. In addition, separate detection collection and matching may be performed for each network and/or syndicated program lineup.

Matching Process: The collected program segment and/or commercial pod detections events that are eligible for match against a specific network or syndicated program lineup may be matched when the Start and End times of a detection event match to, and fall within, the date/time of a network/syndicated lineup. For Program segment and/or commercial pod matching purposes, all data must be reflective of its status and state at the time of the activity being analyzed, not its status or state at the time the query was run. This includes, but is not limited to:
Affiliate lineup date
Segment lineup data
Station lineup data
Monitored station data
Outage data
BIA broadcaster and market population data
TMS program data.

Unscheduled Airings: Unmatched network and syndicated program detections may remain eligible for future matching. However, they are more likely to be considered ‘Unscheduled Airings’ and not matched to any future program lineups. Program detections from unscheduled network or syndicated airings, during the broadcast period being queried and reported, are provided to broadcaster users as reference for the purposes of affiliate management and updating their program lineup data in the online system.

Partial Matches: Partial program clearance matches may include, but are not limited to:
Truncated programs, segments or commercial pods (allowable truncation thresholds may be configurable at the network broadcaster account level);
Incorrect program episodes or segments;
Unaired programs, segments or commercial pods;
Out-of-order program segments.

Unmonitored Stations: Program clearance match data my only be displayed for monitored stations. Monitored stations are identified in either summary or detail tables as having cleared (‘Cleared’), not cleared (‘Not Cleared’), or partially cleared (‘Partially Cleared’) a particular network or syndicated program segment or commercial pod. In addition, only monitored stations are included in program clearance match results represented as a percentage of the country's population. While data results for unmonitored stations are not displayed in online screens, they may be reported to the party ingesting a document at the time of ingest, informing the user of new stations being added to the monitoring network. Additionally, an onscreen link may be displayed with each data set returned, allowing users easy access to a straight listing of unmonitored stations in the data set.

Match Types: The program clearance match types for individual local market affiliate stations may include, but are not limited to:
Cleared
Partially Cleared (see above)
Not Cleared (including possible outage notations)
Unscheduled Airing.

As with Windows Invoice and Schedule matching, match comments or notes are utilized in program and commercial clearance matching to clarify particular match types, on both the network/syndication and the local market affiliate station level. Issues clarified by such notes may include, but are not limited to:
Incorrect program/segment codes
Incorrect broadcast day
Below minimum clearance threshold
Incomplete broadcast day
Prior to airdate
Possible outage.

Table 4 below illustrates an example of the different program clearance match types, the associated match notes and definitions, in accordance with an example embodiment of the present invention. While this table is generated based on the above-described rules, functionalities and features, it is well understood that the incorporation of additional features and functionalities may eliminate certain match types, introduce new match types, or both.

TABLE 4
Example Program Clearance matching match types & notes
PROGRAM CLEARANCE* (matched & reported at the segment level)

| | Match | | |
|---|---|---|---|
| Media Types | Type | Notes | Definition |
| Syndicated | Cleared | | A segment line item on a program schedule for a station |
| Television and pre- | | | included on the station line up for that program that lines up |
| recorded In- | | | with a detection event from that station as follows: |
| Program Network | | | Segment codes match; |
| Radio (No program | | | Lengths match, within +/−30 seconds; |
| clearance for | | | Air dates match; |
| Network Television | | | Start times match, within +/−5 minutes. |
| or Network Radio | Partially | Diff. | A segment line item on a program schedule for a station |
| line networks) | Cleared | Code | included on the station line up for that program that lines up |
| | | | with a detection event from that station as follows: |
| | | | Segment codes do not match, but network and program |
| | | | codes match; |
| | | | Lengths match within +/−30 seconds; |
| | | | Air dates match; |
| | | | Start times match within +/−5 minutes. |
| | Partially | Diff. | A segment line item on a program schedule for a station |
| | Cleared | Length | included on the station line up for that program that lines up |
| | | | with a detection event from that station as follows: |
| | | | Segment codes match; |
| | | | Lengths do not match within +/−30 seconds; |
| | | | Air dates match; |
| | | | Start times match within +/−5 minutes. |
| | Partially | Diff. | A segment line item on a program schedule for a station |
| | Cleared | Date | included on the station line up for that program that lines up |
| | | | with a detection event from that station as follows: |
| | | | Segment codes match; |
| | | | Lengths match within +/−30 seconds; |
| | | | Air dates do not match; |
| | | | Start times match within +/−5 minutes. |
| | Partially | Diff. | A segment line item on a program schedule for a station |
| | Cleared | Time | included on the station line up for that program that lines up |
| | | | with a detection event from that station as follows: |
| | | | Segment codes match; |
| | | | Lengths match within +/−30 seconds; |
| | | | Air dates match; |
| | | | Start times do not match within +/−5 minutes. |
| | Not | | A segment line item on a program schedule for a station |
| | Cleared | | included on the station line up for that program for which no |
| | | | corresponding detection event from that station for that |
| | | | program exists where at least 3 of the 4 match element values |
| | | | (segment code, date, start time +/−5 minutes, or length +/−30 |
| | | | seconds) match, and an outage could not have been |
| | | | responsible for the missing event. |
| | Not | Outage | A ‘Not Cleared’ match type that may have been caused by an |
| | Cleared | | outage. |
| | Not | Un- | A ‘Not Cleared’ match type that was caused by an un-encoded |
| | Cleared | encoded | content. |
| | | Content | |
| | Unscheduled | | Any segment detection event from a station not included on |
| | Airing | | the station line up for that program, OR any segment |
| | | | detection event from a station included on the station line up |
| | | | for that program, for which no unmatched segment line item |
| | | | on a schedule for that program on that station exists where at |
| | | | least 3 of the 4 match element values (segment code, date, |
| | | | start time +/−5 minutes, or length +/−30 seconds) match. |

NOTE:
Unmonitored stations included in lineups displayed in separate table, as per spec.

Overview of Example Change Orders Functionality & Matching

The initial phase of media buying and fulfillment process is the negotiation of the terms of the buy by Agency Media Buyer and Broadcaster Sales Representatives. Generally, the terms negotiated during this initial phase may comprise:

1. The number of individual units of commercial airtime being bought and sold;

2. The length of each of those units;

3. The start and end dates of the campaign flight during which the units are to air;

4. Information regarding the times of the day and/or programs each day during the flight in which these units are to air; and

5. The costs of the units.

Once these initial terms are agreed upon, the Broadcaster creates a Deal/Contract in their internal system, which may then be electronically transmitted to the Agency's media management system (i.e. DDS, Encoda, Datatech, Strata etc), where the Agency users then have read and write access to the data, and where the Agency Schedule is created and populated. Often, many of the originally negotiated terms of the Deal/Contract change between the time it is created in the Agency system, and the time it actually airs and is invoiced by the Broadcaster.

Currently, the documentation of the process of negotiating, authorizing and implementing these changes typically occurs informally offline (phone, fax, email), outside of either the Broadcaster's internal traffic system or the Agency's media management/accounting system. In addition, even if only a single line on an invoice is discrepant relative to the Agency Schedule as currently reflected in the Agency system, the Agency will hold up the entire invoice for payment until that one discrepancy gets researched and resolved.

Change Orders can reflect preemptions, make-goods, credits and additional spots submitted by the Broadcaster and approved by the Agency, thereby resolving discrepancies in advance of any invoicing, and enabling Broadcasters to issue discrepancy-free invoices to the Agency which are immediately payable.

The Online system Change Order Management utilizes three methodologies for Broadcasters to ingest information regarding Missed spots, as well as corresponding Credits and/or Make Good spots:
The “interrogation” of contracts to extract Missed spot and Credit or Make-good information;
Electronic importation of change orders directly from the Broadcaster's system; and
Manual entry.
   Example Matching Rules for Change Orders
   Comparing Deal/Contract to Deal/Contract

Once original Deal and Contract files have been imported into the Online system, it becomes possible to import a revised version and perform “interrogation” against the original document to find the deltas (differences) that will generate change orders in the system.

Since the revision number fields for either the Deal or the Contract may not be populated by the broadcaster, it may be necessary to use the transaction date and time to identify the sequencing of the deal/contract documents. The earliest date represents the original contract, with each iteration sequenced based on the transaction date/time. It is also important not to allow the import of already superceded or outdated files. This can be determined by comparison of the Transaction Date/Time with files already imported for a specific agency/advertiser/network/deal number. For example, if the original deal file was dated Dec. 15, 2003 and an update was received on Jan. 15, 2004, a subsequent re-import of the Dec. 15, 2003 file would not be allowed. Additionally, a file dated Jan. 10, 2004 would not be allowed because a deal with a later transaction date already exists for the agency/advertiser/network/deal number.

A contract schedule line typically consists of various information, including but not limited to:
Agency
Advertiser
Product (Brand)
Network
Transaction Date/Time
Deal Number
Document Number for Contract
Line Number**
Unit Cost
Demo identification (if provided)
Ratings (if provided)
Program
Rotation
Length
Estimate
Monday Week of Date
Start Time
End Time
Unit Count*
Serial Number*
   *NOTE ON SERIAL NUMBERS AND UNIT COUNT For Unit Counts higher than 1, additional serial numbers can be inferred. The serial number listed for a line with more than one unit will be the starting number and additional units will increment the serial number by one.
   **The Line number may not be consistent from iteration to iteration, but will be used to group units with like characteristics.
   Example Comparison to Identify Removes and Adds

The matching of the original contract to the revised contract may involve two comparisons. The first comparison looks for serial numbers that have been removed and serial numbers that have been added (the second comparison involves identity changes for the same serial number, and is discussed separately in a subsequent section). The results of the first type of comparison may be classified as “removes” and “adds” and placed into the appropriate classification panel of the GUI. The following represents an example method for conducting the comparisons.
Serial Number is the primary key for comparison:
   Missing serial numbers should be flagged as REMOVED for inclusion on a change order (If a serial number WAS present in the previous iteration of the contract, but is not present in the current iteration, it has been removed from the contract).
A removed spot shall be eligible for classification via the GUI as a pre-empted spot (which must be associated with a make-good in the GUI), a missed spot or a credited spot.
   Additional serial numbers should be flagged as ADDED for inclusion on a change order (If a serial number—other than inferred serial numbers*—was NOT present in the previous iteration of the contract, but is present in the current iteration, it has been added to the contract).
An Added spot shall be eligible for classification via the GUI as an addition to the schedule, a make-good spot (which must be associated with a pre-empted spot in the GUI), an ADU spot or a Bonus spot.
   Example Classification and Association of Removes and Adds

The Change Order module of the Online system supports association and classification of removes and adds. The deal/contract alone does not provide a mechanism to track the association of one or more removed item with one or more added item. The Change Order module allows for this tracking via an interactive web interface. This process is external to the deal/contract matching process, and provides the ability to associate data associated with missing serial numbers (also referred to earlier as Removed Units) to data associated with added serial numbers (also referred to earlier as Added Units) using an Interface. The associations made via the GUI are made durable when a change order has been approved, which means that this user-created association has to survive and not be impacted, altered or broken by future imports of revised files. One unit may be replaced with multiple, lower value units or two or more lower value units may be replaced with a lesser number of higher value units. Associations may include: one to one; one to many; many to one; many to many.

Example Methodologies for Creating Durable Associations

Because the contract does not provide associations between pre-emptions/make-goods, original/split or original/combine units, it is necessary for the Online system to handle such associations. A “durable” association is one where associations can survive the import of a new file for any associations made for change orders submitted and accepted by an agency. This is necessary so broadcasters do not have to recreate associations each time a new contract is imported. A methodology to allow for durable associations must be implemented in support of Change Management.

One possible solution to making durable associations is the creation and assignment of a “hidden” serial number within the system database 10. The hidden serial number contains a cross-reference to the “remove” and “add” serial numbers the broadcaster has associated via the interface. This hidden or “ghost” serial number enables the maintenance of the relationships established by the broadcaster between serial numbers for change orders that have been approved and accepted by the agency. Another possible methodology is to create the association within the database without creating an actual serial number, but instead using an association table linking serial numbers.

It is possible that a grouping created by a hidden serial number and approved by an agency may be changed again in a future iteration of the contract, so the interface and database should allow for some flexibility in this area. The methodology used will be determined by the development group.

Example Impact of Changes to Spot Lengths

Another way agency changes may be made to a broadcaster deal/contract, that will not be evident simply by importing a new file, is through changes to the mix of unit lengths within a deal/contract. An agency may negotiate a deal with specific spot lengths, but wish to change those spot lengths prior to airing. The result of this is the removal of one or more serial numbers and the addition of one or more serial numbers. This type of change also requires “durable” associations to be made upon approval of the change orders (see above).

Splits

An agency may negotiate a deal containing all 30-second units. However, when they negotiate the actual contract with the broadcaster, they may wish to replace some or all of the 30-second units with 15-second units. This would result in the effected 30-second unit serial numbers being removed and two 15-second unit serial numbers being added to replace each of the original 30-second units. This is classified as a SPLIT. This classification should be visible to both broadcaster and agency users. A split consists of a pre-empted unit and two or more makegood units.

Combines

An agency may negotiate a deal containing all 15-second units. However, when they negotiate the actual contract with the broadcaster, they may wish to replace some or all of the 15-second units with 30-second units. This would result in two effected 15-second unit serial numbers being removed for each 30-second unit serial number being added to replace each of the original 15-second units. This is classified as a COMBINE. This classification should be visible to both broadcaster and agency users. A combine consists of two or more pre-empted units and one makegood unit.

For any change order that requires broadcaster intervention in order to provide complete and actionable information to the agency, an aggregated email may be sent to the broadcaster alerting them to access the change order module on the website in order to complete the process.

Example Comparison to Identify Changes for Same Serial Number

The second comparison may be conducted for serial numbers that are found in both files. For each deal/contract unit for a specific network/agency/advertiser, the following fields may be compared and deltas flagged for inclusion in a change order:
The Monday week of date should match, deltas should be flagged for inclusion on a change order
The Unit count should match, deltas should be flagged for inclusion on a change order
The Rotation should match, deltas should be flagged for inclusion on a change order
The Cost should match, deltas should be flagged for inclusion on a change order
The program should match, deltas should be flagged for inclusion on a change order
The start time should match, deltas should be flagged for inclusion on a change order
The end time should match, deltas should be flagged for inclusion on a change order
   Example Matching for Units that do not Contain a Unique Serial Number

Lines and units that do not have unique serial numbers may be matched using the line number/serial number as a combined key. If the line number/serial number is found in both files, then a comparison of the data within the line must be completed. If changes are found, a change order can be automatically generated and placed into the change order panel of the GUI. The Original serial number information can be displayed and marked as a Pre-Empt. The Current serial number information can also be displayed and marked as a Make-Good. If a line number/serial number is found in the first file but not found in the second file, the unit may be classified as a Removed Unit and placed in the categorization panel of the GUI. If a line number/serial number is not found in the first file but is found in the second file, the unit may be classified as an Added Unit and placed in the categorization panel of the GUI. If line numbers are not consistent from file to file (and there is no sample revised version of the original file), then the entire file may be placed into the categorization panel for association by the broadcaster. Unfortunately, without unique serial numbers, it is difficult, if not impossible to prevent this outcome.

Any comparison that generated one or more deltas would result in the generation of a change order. If a change order contains all the information required in order for it to be forwarded to an agency for approval, then the change order may be automatically generated and placed into the Change Orders panel for the broadcaster to assign the buyer and submit to the agency. If rejected, the changed unit is placed in the incomplete change order state and requires a new contract upload to resolve it.

Example Matching Associations Life Cycle

When an agency rejects a change order, the broadcaster associations that were made on that change order are released and the “hidden” system issued serial number is deactivated.

When a change order containing broadcaster associations is in a Submitted state (meaning it has not been approved or rejected by an agency) AND a new contract is imported, a check of the new contract to determine if the associated serial numbered items remained the same may be conducted. For any items where changes occurred to an associated serial number, the association of all items for that unit may be released and available for re-association by the broadcaster. The affected change order may also be withdrawn from the agency view so it could no longer be approved or rejected, but may instead be replaced by a new change order after broadcaster association had taken place. However, if associated items remained unchanged, the pending change order may remain on the agency view and action on it would be allowed.

Example Matching Deal/Contract to Detections

The core of the OnLine system is the system's ability to associate specific detection events to specific schedule events for a broadcaster or agency schedule. The “schedule” that detections need to be matched against in this case may take the form of a broadcaster deal/contract. Once the airdate for the contracted unit has passed, the unit becomes eligible for matching against detections within the Online system.

Matching against a specific deal/contract follows the same basic criteria as matches done against an agency schedule. ISCIs will not be present on a broadcaster deal/contract, so the industry code will not be a matching criteria for this type of match. The matching process may consider all deal/contracts that have been imported into the system, relative to the set of all qualifying detections in the system. Unmatched detections may be eligible for matching against any deal/contract for which the detections meet the collection criteria.

The matching process may use a set of collection criteria to select detections from the database that are eligible to be matched with a specific agency schedule. An example of such criteria may comprise:
Detections shall be considered eligible for matching with a contract only if its broadcaster, advertiser, agency, product (including aliases), and length are the same as that of the contract.
Detections shall be considered eligible for matching with a contract when the detection start time is the same or later than the earliest contract interval start time minus the pre-tolerance.
   Pre-tolerance should be a configurable setting within the system. There should be a system-wide pre-tolerance setting for contracts and an account-level configurable setting for contracts. Initially, the system-wide pre-tolerance may be set at 3 minutes.
Detections shall be considered eligible for matching with a contract when the detection start time is the same or earlier than the latest contract interval end time plus the post-tolerance.
   Post-tolerance should be a configurable setting within the system. There should be a system-wide post-tolerance setting for contracts and an account-level configurable setting for contracts. Initially, the system-wide post-tolerance shall be set at 3 minutes.
The matching process will use spot cost* in preferential weighting of matches, but will not use cost to determine eligibility.
   *Cost per detection may be established after the invoice to detection match has been performed. After the invoice matching has occurred, the detection may have the cost from the invoice appended to the detection record. This cost may then be used in preferential weighting of matches for broadcaster contracts and agency schedules.

Matching for deal/contracts generally mimics matching against agency schedules, since the broadcaster contract is usually a pre-cursor to the agency schedule and contains basically the same information. However, there are typically no partial matches for contract to detection matching. If a match is not perfect, including pre- and post-tolerances for time, then the detection and contract units both remain unmatched.

Online system outages must be considered for matching. If a system outage occurs during a contract schedule line period for which there is no matching detection, the contract schedule line must be flagged as a potential outage. Unencoded ISCIs may also be taken into consideration for contract matching, with the broadcaster being advised of this as a possible cause for a missed verification. A list of ISCIs detected within the Online system for the broadcaster/agency/advertiser may be part of an email to the broadcaster, advising them of the need to complete change orders against a particular deal.

Example Overview of Traffic Alerts Functionality & Matching

Agency Schedules do not generally include spot codes (though they may). Therefore, another important element of the media buying and fulfillment process is the development and distribution of Agency Traffic Instructions.

The Agency Traffic Manager may determine which specific commercials (based on spot codes such as ISCI) are to air during each of the units of commercial airtime represented on the Agency Schedule. Once determined, the Agency Traffic Manager then communicates this information as Agency Traffic Instructions to a Traffic Manager at the broadcaster, who in turn schedules the specific spot codes for each advertiser into each slot of their broadcast schedules.

Agency Traffic Instructions play a critical role for the Traffic Alerts module of the Online system by allowing Agency and Broadcaster users to set and receive alerts whenever individual or groups of specific spot codes air outside of Agency Traffic Instructions and/or additional user-defined broadcast parameters. Various types of Traffic Alert events may be supported by the Online system, including but not limited to:
Incorrect Rotations: Detections of specific spot codes airing in a rotation percentage (of the total number of units scheduled) other than the rotation percentages detailed in the Agency Traffic Instructions for each spot code (assumes the Agency Traffic Instructions include rotation information.)
Missed Upload Date: No encoding metadata uploaded within a user-defined number of days prior to the flight start date defined in the Agency Traffic Instructions (agency feature only);
Missed Start: No detections of specific spot codes from a specific broadcaster within a user-defined number of days after the flight start date defined in the Agency Traffic Instructions;
Out-of-Flight: Detections on any broadcaster before or after the flight start dates/times and end dates/times defined in the Agency Traffic Instructions;
Blackout Periods: Detections during user-defined in-flight blackout periods (e.g. M-Su 12A-6A); and
Incorrect Broadcaster: Detections on networks (National Cable) or stations (Spot Television or Spot Radio) not included in Agency Traffic Instructions (agency feature only).
   Example Hi-Level Functional Requirements for Traffic Alerts

The broad sets of functionality required for the release of Online system Traffic Alerts include, but are not limited to:

1. User Permissioning: Administrative functionality to allow Customer Admin users to assign user Traffic permissions to all system users with national cable, spot radio and/or spot television media type permissions as either view-only or set/clear/edit users.

2. Importing Traffic Instructions: Import functionality to allow Agency Traffic users to electronically import Agency Traffic Instructions into the online system.
Agency users only;
Import functionality to provide onscreen import options specific to traffic instructions file formats;
Capability to provide users with onscreen and emailed feedback regarding success/failure of traffic instructions imports;

Capability to provide filtering and display options specific to imported traffic instructions file summaries.

3 Viewing Traffic Instructions: The ability to view a detailed onscreen summary of the Agency Traffic Instructions data imported into the system, and upon which alert settings and data are based.
All agency and broadcaster users;
A data parameters panel for filtering traffic instructions data to display;
Ability to export to Excel;
View only (Users may not create or modify traffic instructions in the system. Traffic instructions may only be created or modified in Agency systems and then ingested into the system.).

4. Setting, Activating & Modifying Alert Parameters: Onscreen capabilities for permissioned users to define parameters for onscreen and auto-email traffic alerts.
Permissioned agency and broadcaster users (vs. users with default ‘view-only’ permissions);
Ability to:
   Set and activate new alert parameters; and
   Edit or delete existing alert parameters;
For all traffic event types, including but not limited to:
   Incorrect Rotation
   Missed Upload
   Missed Start Date
   Out-of-Flight
   Blackout Period
   Incorrect Broadcaster

5. Matching Rules & Logic: Matching rules and logic to compare activity detected (or not detected) for specific spot codes to expected activity, based on ingested agency traffic instructions and user-entered alert parameters.

6. Viewing Alert Data: The ability to view data regarding broadcast activity that is not in compliance with the parameters defined in the Agency Traffic Instructions and/or the additional user-defined traffic event alert parameters within the system.
All permissioned agency and broadcaster traffic users (‘View’ is the system default permission for all users);
Ability to view alert data for all traffic alert event types, including but not limited to:
   Incorrect Rotation
   Missed Upload
   Missed Start Date
   Out-of-Flight
   Blackout Period
   Incorrect Broadcaster;
A data parameters panel for filtering alert data to display;
Summary tables with links to Detail tables;
Displays data for new and/or uncleared alerts;
Option to clear alerts (specially permissioned users only);
Option to view data for previously cleared alerts (all users);
Option to view complete rotation data; (agency users only);
Ability to view unmonitored broadcasters (all users);
Option to email alert event data to broadcaster (Agency users only); and
Ability to export data.

7. Receiving Auto-Email Notifications:
New Agency Traffic Instructions imports (Agency and broadcaster users);
New Traffic Alerts set by Agency Users (Broadcaster users only); and/or
New Alert events (Agency and broadcaster users).

8. Setting Email Notification Preferences: Onscreen capabilities for Agency and Broadcaster Users to opt in or out of auto-email notification of:
New Agency Traffic Instructions imports (Agency and broadcaster users);
New Traffic Alerts set by Agency Users (Broadcaster users only); and/or
New Alert events (Agency and broadcaster users).
   Example Matching Rules for Traffic Alerts
   Pertinent Fields for Matching:
   Traffic Instruction Fields

A set of traffic instructions uploaded to the Online system by an agency may contain various information, including but not limited to:
Agency
Traffic Instructions ID
Advertiser
Product (Brand)
Estimate Number
Estimate Name
Media Type (See below Section titled Media Type)
Broadcaster(s)*
Start Date
End Date
Spot Code(s)
Length
Rotation Percentage (optional)
   *In some instances broadcasters are not specifically identified but are designated as “All”. In these cases, some alarms and access to traffic instructions may not be available to broadcasters.

A Datatrak traffic instruction file may contain multiple estimates for multiple media types. Each estimate may have multiple traffic instruction IDs (traffic letter number) associated with it. Each traffic instruction ID should be treated as a separate traffic instruction set.

Validation of Media Type

Determining the media type for the traffic instructions may be handled during the validation step of import, and traffic instructions for multiple estimates may be contained within the same file. Since multiple media types may also be contained within the same traffic instructions document (for example, broadcast network, cable and syndication in the network version and spot television and local cable in the spot version), a two-step identification process may be necessary.

First, the media type should be examined. If the media type does not agree with all broadcasters contained within the document (using a lookup of call sign to media type within the system database 10), it may be necessary to use the estimate number (code) and estimate name to determine the media type. For example, the estimate number (code) may contain N to indicate network, C to indicate cable or NSY to indicate network syndication and the estimate name may contain the media type information, as well. It may be necessary to use a combination of estimate number (code) and estimate name. If the estimate number (code) differentiates by using T for TV and C or LC for local cable, the media type can be identified this way. If the estimate number (code) doesn't differentiate, it will be necessary to go to the estimate name to see if the media type can be identified through this field.

If it is not possible to determine the media type via the estimate number (code) or estimate name then the import process for traffic instructions may send notification to the customer support team so the media type can be obtained from the customer (e.g., manual intervention may be required in the database to identify the media type appropriately). The imported file may require revalidation and rematching once the media type has been established.

Traffic instructions may contain additional information that may help to further define the instructions to the broadcaster. But for matching purposes, the above fields may be sufficient.

Example Data Needed for Matching

Content Records

Content records contain the spot code (ISCI in most cases). The spot code may be the primary comparison used against traffic instructions. Spot Codes may be compared only after case, dashes or spaces have been removed. It may be necessary to look up the content record in the system database 10 so that the media type designated for that specific spot code can be identified. The media type on the content record must match the media type on the traffic instructions (including any aliasing) in order for that spot code to be considered for alarm generation.

The media type field in the content records defines the type of media that the content record will be aired on. For example, a media type of ‘Spot Television’ would indicate that the spot code is destined for airing on local television stations as part of a spot schedule. There are at least seven media types that can be selected on a specific content record, with only one media type allowed per content record: television, radio, cable, broadcast network, syndication, network radio, other. The “other” designation indicates that the spot code can air on multiple media types.

Detections

Detections may be eligible for matching to a specific traffic instruction document if they match the spot code (after case, dashes and spaces have been removed) found in the document. If the spot code cannot be matched, then detections for the advertiser, product/brand, broadcaster and media type indicated on the traffic instructions are eligible. Aliasing must be taken into consideration with matching to an alias being given the same weight as an exact match.

Station Coverage

Alarms may only be generated for monitored broadcasters. It is necessary to check the broadcaster name (including aliasing) in the system database 10 to make certain that alarms can be generated. Broadcasters that are not monitored may be designated as “unmonitored” in the traffic instructions UI. For broadcasters that have changed call signs during the period of the traffic instructions, the current call sign may be checked and if that is not found, the previous call sign may be checked for matching detections to traffic instructions. Traffic instructions may be matched to a detection for a station when a match is found for the current call sign or the previous call sign, with the current call sign taking precedence. Matches made against previous call signs may be designated as such on the UI if alarms are generated for them.

Station Outage data

A look up of system outage information must be done prior to an alarm being generated. Alarms generated for broadcasters during system outages shall include the note “possible outage”.

Example Basic Alarm Logic

Matching of detections to traffic instructions may be a daily process that takes place after the last AEC run, after the end of the broadcast day (e.g 6:40 am AEC run). Detections received each day may be matched against traffic instructions in the system to generate alarms that are delivered to the user's inbox, and made available on-screen, by a designated time (e.g., no later than noon eastern for the preceding broadcast day). Late events must also be included and should be matched on the broadcast day they are received.

In order for Traffic Alarms to be generated, they must be ‘set’ by a user. The system should prevent duplicate alarms from being set.

The following describes examples of the basic alarm generation logic for at least six alert types designed to be supported by the Online Traffic module:

Missed Upload Date

1. Verify that all ISCIs (spot codes) on traffic instructions are present in the content database
a. If yes, stop—no alarm
b. If no, continue

2. Verify that the user-defined number of days prior to the start date of the traffic instructions has passed
a. If yes, issue an alert
b. If no, stop—no alarm
   Missed Start Date

1. Verify that at least one of the spot codes (ISCIs) on traffic instructions for which alarms have been set are present in the content database
a. If yes, continue
b. If no, stop—no alarm

2. Verify that the user-defined number of days prior to the start date of the traffic instructions has passed
a. If yes, continue
b. If no, stop—no alarm

3. Verify that detections have been received for any of the spot codes on traffic instructions for which an alarm has been set
a. If yes, stop—no alarm
b. If no, issue an alert
   Out-of-Flight

1. Verify that detections have been received for specified advertiser/product/broadcaster
a. If yes, continue
b. If no, stop—no alarm

2. Verify traffic instructions have been received for specified advertiser/product/broadcaster/spot code
a. If yes, continue
b. If no, issue an alert

3. If traffic instructions have been received for specified advertiser/product/broadcaster/spot code, verify the detections fall between the traffic instructions start date and the traffic instructions end date
a. If yes, stop—no alarm
b. If no, issue an alert
   Blackout Period

1. Verify that user-defined blackout period has been set
a. If yes, continue
b. If no, stop—no alarm

2. Verify that detections have been received for the spot codes on traffic instructions for which alarms have been set
a. If yes, continue
b. If no, stop—no alarm

3. Verify that the start date of the traffic instructions has passed
a. If yes, continue
b. If no, stop—no alarm

4. Verify that the end date of traffic instructions has passed
a. If yes, stop—no alarm
b. If no, continue

5. Verify that time of detection is within user-defined blackout period
a. If yes, issue an alert
b. If no, stop—no alarm
   Incorrect Broadcaster

1. Verify that traffic instructions have been imported for agency/advertiser/product and media
a. If yes, continue
b. If no, stop—no alarm

2. Verify that broadcaster is found on traffic instructions
a. If yes, stop—no alarm
b. If no, issue an alert
   Incorrect Rotation

1. Verify that traffic instructions have been imported for agency/advertiser/product/broadcaster
a. If yes, continue
b. If no, stop—no alarm
   2. Verify that rotation percentage has been defined in imported traffic rotations
a. If yes, continue
b. If no, stop—no alarm

3. Verify that detection dates are after traffic instruction start date
a. If yes, continue
b. If no, stop—no alarm

4. Verify that detection dates are prior to traffic instruction end date
a. If yes, continue
b. If no, stop—no alarm

5. Verify that broadcaster is contained within traffic instructions
a. If yes, continue
b. If no, stop—no alarm

6. Verify that spot codes for which alarms have been set are contained within traffic instructions
a. If yes, continue
b. If no, stop—no alarm

7. Verify that user-defined rotation variance has been entered on the Online system
a. If yes, continue
b. If no, use system default of 10% and continue

8. Calculate rotation percentage (total airings of each spot code divided by the total number of spots aired for advertiser/product within specified timeframe)

9. Compare to rotation percentage defined in the traffic instructions and calculate whether the rotation percentage for a given spot code is within user-defined rotation percentage variance or system default of 10%
a. If yes, stop—no alarm
b. If no, issue an alert
   Appending Schedule Data w/Traffic Spot Codes

In addition to being used to set and generate traffic alerts, spot codes from traffic instructions can be appended to schedule data in such a way as to generate a list of valid spot codes for each agency schedule in the online system, which allows for more granular schedule vs. detections data matching at the spot code level, including the ‘Partial Match’ match type and the ‘Wrong Code’ match note for schedule lines that come in without spot codes.

It should now be appreciated that the present invention provides advantageous methods and apparatus for broadcast program stewardship.

Although the invention has been described in connection with various illustrated embodiments, numerous modifications and adaptations may be made thereto without departing from the spirit and scope of the invention as set forth in the claims.

What is claimed is:

1. A method for broadcast program stewardship, comprising:
monitoring broadcast multimedia content to produce detection information relating to one or more broadcast instances of one or more broadcast items;
receiving schedule information related to said one or more broadcast items; and
comparing the detection information against said schedule information.

2. The method of claim 1, wherein, for each of said one or more broadcast items, said detection information comprises at least one of:
date and time of said broadcast item;
duration of said broadcast item;
type of broadcast of said broadcast item;
owner of said broadcast item;
title of said broadcast item; and
at least one code associated with said broadcast item.

3. The method of claim 1, wherein said detection information is produced in accordance with at least one of a broadcast monitoring coverage and a station outage data.

4. The method of claim 1, wherein said detection information is produced in accordance with watermarks extracted from said one or more broadcast items.

5. The method of claim 1, wherein said detection information is produced in accordance with fingerprints extracted from said multimedia content.

6. The method of claim 1, wherein said broadcast items comprise at least one of commercials, infomercials, television programs, radio programs, news programs, cable programs, satellite programs, podcasts, Internet broadcasts, downloads, and broadcasts of live events.

7. The method of claim 1, wherein said schedule information comprises purchase details relating to each of said one or more broadcast items.

8. The method of claim 7, wherein said purchase details comprise at least one of:
a seller's name;
a purchaser's name;
a purchaser's product(s) being promoted;
an estimate number corresponding to the purchase;
an invoice number corresponding to the purchase;
a number of agreed upon contract units;
a number of invoiced units;
a length of the contract units to be broadcast;
a length of the invoiced units;
broadcast dates and times of the contract units;
broadcast dates and times of the invoiced units;
negotiated costs for each contract unit; and
invoiced costs for each invoiced unit.

9. The method of claim 1, further comprising:
receiving additional information comprising at least one of an agency schedule, a broadcaster contract, a broadcaster invoice, a network affiliate lineup, a station lineup, agency traffic instructions, change order information, broadcaster program schedule data, broadcaster data, market population data, and audience measurement ratings data to effect said comparing.

10. The method of claim 9, wherein at least a portion of said additional information is received electronically.

11. The method of claim 10, wherein said electronically received information is automatically uploaded into a database.

12. The method of claim 9, wherein at least a portion of said additional information is manually uploaded into a database.

13. The method of claim 9, wherein at least a portion of said additional information is received from users in accordance with pre-defined security permission levels.

14. The method of claim 13, wherein said permission levels comprises at least one of:
a customer account level;
a customer administrator level; and
a user level.

15. The method of claim 1, wherein said schedule information is received electronically and automatically uploaded into a database.

16. The method of claim 15, wherein at least a portion of said schedule information is received from users in accordance with pre-defined security permission levels.

17. The method of claim 16, wherein said permission levels comprises at least one of:
a customer account level;
a customer administrator level; and
a user level.

18. The method of claim 1, wherein said comparing comprises matching said detection information and said schedule information in accordance with a matching algorithm.

19. The method of claim 18, wherein said matching algorithm comprises at least one of:
a hierarchical matching algorithm;
a point-to-point matching algorithm; and
a point-to-range matching algorithm.

20. The method of claim 1, wherein said comparing comprises:
selecting one or more matching criteria;
assigning weighted scores to the selected matching criteria; and
matching said detection information and said schedule information in accordance with said matching criteria and said weighted scores.

21. The method of claim 20, wherein a match is declared if all of said matching criteria are satisfied.

22. The method of claim 20, wherein a partial match is declared if at least one of said matching criteria is satisfied.

23. The method of claim 20, wherein no match is declared if none of said matching criteria is satisfied.

24. The method of claim 1, further comprising:
enabling generation of a report based on said comparing.

25. The method of claim 24, wherein said report is provided on-line.

26. The method of claim 24, wherein said report comprises at least one of:
an agency schedule to detections match;
an agency schedule supplemented with network affiliate lineup data to detections match;
an agency schedule supplemented with station lineup data to detections match;
a broadcaster invoice to detections match;
a broadcaster contract or deal to detections match;
a broadcaster contract or deal to broadcaster contract or deal match;
an agency traffic instructions to detections match;
change order information to detections match; and
a broadcaster program schedule to detections match.

27. The method of claim 26, wherein said matches comprise at least one of:
detections supplemented with broadcaster data;
detections supplemented with market population data; and
detections supplemented with audience measurement ratings data.

28. The method of claim 24, wherein at least portions of said report are accessible in accordance with predefined security permission levels.

29. The method of claim 28, wherein said security permission levels comprise at least one of:
a customer account level;
a customer administrator level; and
a user level.

30. The method of claim 24, wherein at least portions of said report are electronically exportable.

31. The method of claim 1, further comprising generating traffic alerts.

32. The method of claim 31, wherein said traffic alerts identify inconsistencies between agency traffic instructions and said detection information.

33. The method of claim 32, wherein said inconsistencies comprise at least one of:
an incorrect rotation;
a missed upload date;
a missed start;
an out-of-flight broadcast;
a blackout period broadcast; and
an incorrect broadcaster.

34. The method of claim 1, wherein said comparing is effected in accordance with change order information.

35. The method of claim 34, wherein said change order information is produced in accordance with least one of interrogation of broadcaster contracts, direct importation of said change order information from broadcasters, and manual entry of said change order information.

36. The method of claim 35, wherein said change order information comprises at least one of:
unassociated added units;
unassociated removed units; and
pre-associated added and removed units.

37. The method of claim 36, wherein said change order information comprises at least one of:
sellers associating unassociated added and removed units and submitting them to a buyer; and
sellers submitting pre-associated added and removed units to a buyer.

38. The method of claim 37, wherein said change order information comprises at least one of:
submitted change order information approved by the buyer; and
submitted change order information rejected by the buyer.

39. The method of claim 1, further comprising:
receiving invoice information related to said broadcast items;
comparing the detection information against said invoice information.

40. The method of claim 39, wherein said invoice information comprises at least one of original invoice information and change order information related to said original invoice information.
